(19) United States
(12) Patent Application Publication
(10) Pub. No.: US 2026/0340526 A1
(43) Pub. Date: Oct. 29, 2026

(54) SYSTEM

(71) Applicant: SoftBank Group Corp., Tokyo (JP)

(72) Inventor: Takeshi TANAKA, Tokyo (JP)

(73) Assignee: SoftBank Group Corp., Tokyo (JP)

(21) Appl. No.: 19/649,208

(22) Filed: Apr. 16, 2026

(30) Foreign Application Priority Data
Apr. 23, 2025 (JP) 2025-071647

(51) Int. Cl. G06Q 10/0631; G06F 40/20; G06N 3/0475

(52) U.S. Cl. CPC G06Q 10/0631; G06F 40/20; G06N 3/0475

(57) ABSTRACT

The present invention relates to an automatic processing system for radio wave countermeasure projects that comprises a project information acquisition unit, a generative AI analysis unit, a project determination unit, a project classification unit, a construction company selection unit, an ordering processing unit, a main person-in-charge assignment unit, and the like for radio wave countermeasure projects from corporate customers and sales representatives, acquires diverse information such as building information, site photographs, drawings, and customer requests, and collates and analyzes the information with a past similar project database using generative AI, thereby seamlessly automating information deficiency determination for each project, inference of an optimal countermeasure method, project classification, automatic selection and ordering of a construction company, automatic assignment of a main person in charge, progress management, and history management, and realizes business efficiency improvement, optimal allocation of human resources, cost reduction, and customer satisfaction improvement.

### CROSS-REFERENCE TO RELATED APPLICATION

The present application claims priority to and incorporates by reference the entire contents of Japanese Patent Application No. 2025-071647 filed in Japan on Apr. 23, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that, in a huge number of radio wave countermeasure projects received from corporate customers and sales representatives, conventionally, a person in charge confirmed excess or deficiency of information for each project, assigned a main person in charge for each request source department or corporation, and further manually performed examination of a countermeasure method and ordering to a construction company, which required a great deal of time and effort for project processing, made it impossible to allocate sufficient resources to important projects and complex projects to be focused on, and resulted in a necessity to outsource a part of determination and assignment work, leading to an increase in business costs, processing delays, and a decrease in customer satisfaction. Furthermore, regarding standard radio wave countermeasure projects that account for the majority of the projects, although patterning is possible from past countermeasure histories and site conditions, there is also a problem that efficiency improvement and automation of business do not progress and effective utilization of human resources is difficult because they rely on personal judgments and manual work. In addition, a problem has also become apparent that a lead time from application to ordering to the construction company is prolonged due to taking time to confirm deficiencies in application information and project contents, making it impossible to respond to a prompt response request from the customer. In order to solve these problems, an object of the present invention is to realize a significant improvement in business efficiency, optimal allocation of human resources, cost reduction, and improvement in customer satisfaction by automating a series of business processes at high speed and with high accuracy, such as automatic acquisition of project information, automatic determination of information deficiency, automatic collation with past histories, automatic classification of projects, automatic selection and ordering of a construction company, and automatic assignment of a main person in charge, utilizing generative AI.

### SUMMARY OF THE INVENTION

A means for solving the problems according to the present invention is to configure an automatic processing system for radio wave countermeasure projects comprising a project information acquisition unit, a project determination unit, and a project processing unit. First, the project information acquisition unit electronically receives project information such as building information, floor information, surrounding base station information, drawings, and person-in-charge information from a customer or a sales representative, and stores these pieces of information in a database. Next, the project determination unit collates the received project information with a past radio wave countermeasure history database using generative AI, analyzes a plurality of elements such as a building, a floor, the number of surrounding base stations, a past countermeasure pattern, and a radio wave countermeasure status of surrounding buildings from multiple perspectives, thereby automatically determining presence or absence of information deficiency in application information, and further automatically classifies whether the project is a simple project solvable by installing a standard amplifier or a small base station, or a complex project requiring installation of a special amplifier, a new base station, or the like.

The project processing unit, based on a determination result of the project determination unit, automatically executes selection of a construction company and ordering processing using the generative AI in a case where the project is determined to be the simple project, performs automatic assignment of a main person in charge in a case where the project is determined to be the complex project, and further automatically performs a return notification to an applicant in a case where the information deficiency of the project information is determined. Thereby, a series of business processes from project reception to determination, assignment, and ordering can be automated at high speed and with high accuracy, and improvement in business efficiency, optimal allocation of human resources, cost reduction, and improvement in customer satisfaction can be realized.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

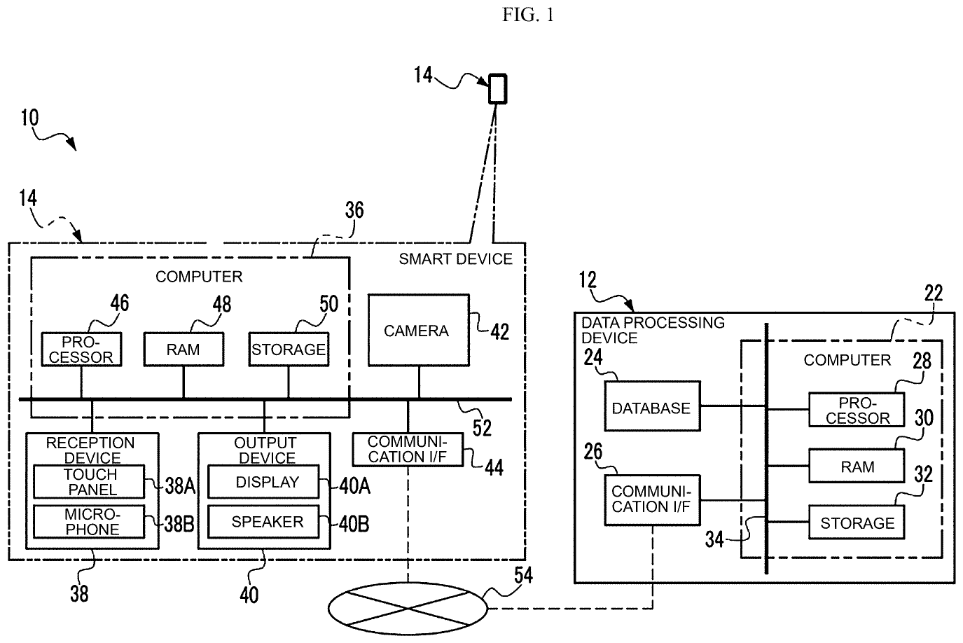

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

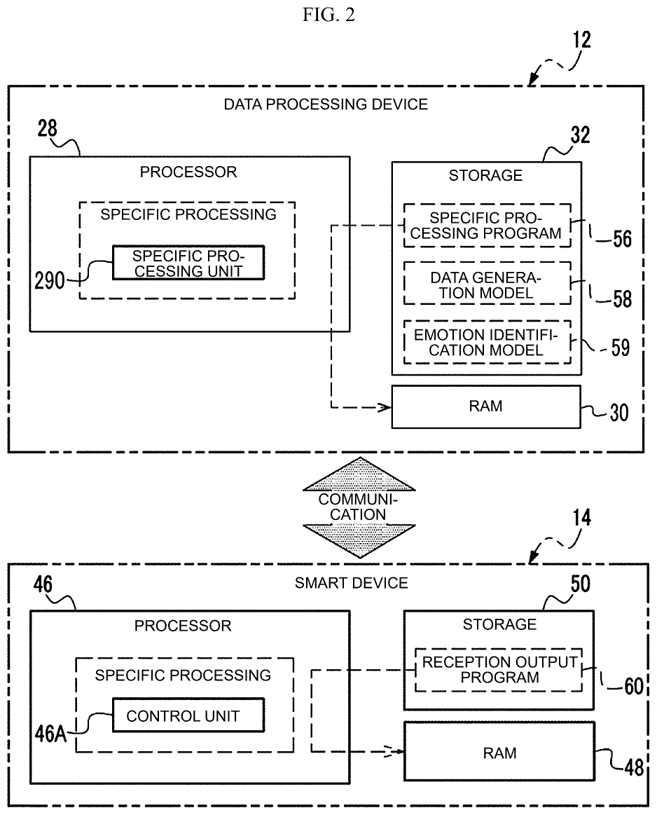

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail.

The automatic processing system for radio wave countermeasure projects of the present invention is composed of a server and a terminal. The terminal is a personal computer, a tablet, a smartphone, or the like for a customer or a sales representative to input project information, and the server is a high-performance computer system responsible for core processing such as aggregation, analysis, determination, processing, and history management of the project information, and execution of a generative AI model. The terminal and the server are communicably connected via a network, and the information input from the terminal is transmitted to the server in real time. Specifically, the present system adopts a distributed computing architecture. The present server is composed of a plurality of computing nodes. Each computing node includes a dedicated arithmetic circuit for executing a large-scale language model and an image recognition model in parallel. The present terminal has a preprocessing unit configured to convert input unstructured data into structured data. The present preprocessing unit converts an input text into a word vector. The present preprocessing unit converts an image into a multidimensional tensor. The present terminal transmits the converted data to the present server via a secure communication protocol. The present server temporarily stores the received data in an in-memory database. The present in-memory database realizes high-speed data reading and writing. The present server distributes the data to each processing module using an asynchronous processing queue. With this configuration, the present system minimizes processing delay even for a large amount of simultaneous accesses. The present system exhibits a technical effect of reducing a communication load. The present system enables real-time project processing. The present system is applicable to use cases such as maintenance work of communication infrastructure and facility management work in a large-scale facility.

The project information acquisition unit receives project information from a customer or a sales representative through an input screen via a dedicated application or a web browser on the terminal. The input information is diverse, such as a building name, a building address, a building type (for example, an office building, a commercial facility, a factory, a hospital, a school, or the like), a floor number, a floor area, the number of surrounding base stations, a model of a surrounding base station, drawing data (a PDF, a CAD file, an image file, or the like), a site photograph, person-in-charge information (name, contact information, affiliated department), a request source department information, a customer attribute (a large corporation, a small and medium-sized corporation, a public organization, or the like), a radio wave intensity measurement value (for example, −95 dBm, −80 dBm, or the like), a desired handling time, presence or absence of a past countermeasure history, special circumstances of the site (for example, presence or absence of an obstacle, an underground floor, a rooftop, a special structure, or the like), and a request from the customer (for example, “desire for short delivery time”, “desire for night construction”, “desire for simultaneous handling of multiple floors”, or the like). For example, there is a case where the sales representative inputs detailed information from the terminal, such as “7th floor of office building A in Tokyo, floor area is 500 square meters, 3 surrounding base stations, site photograph and drawing file attached, person in charge is Mr. B, request source is corporate sales department, customer attribute is large corporation, radio wave intensity at the site is −90 dBm, desired handling within 1 month, underground floor with many obstacles, past record of amplifier installation on the 5th floor of the same building, desire for night construction”. The terminal transmits such information to the server, and the project information acquisition unit on the server side stores the information in a database. Specifically, the present project information acquisition unit analyzes the input text data using a natural language processing technology. The present project information acquisition unit extracts a keyword from the text data using a named entity recognition algorithm. The present project information acquisition unit maps the extracted keyword to a multidimensional vector space. The present project information acquisition unit applies a convolutional neural network to the image data. The present project information acquisition unit generates a feature map from the image. The present project information acquisition unit extracts vector-format line segment information from the drawing data. The present project information acquisition unit converts the extracted line segment information into graph structure data. The present project information acquisition unit integrates these heterogeneous data to generate one multimodal feature vector. The present multimodal feature vector is expressed as, for example, a 512-dimensional floating-point array. The present project information acquisition unit saves the generated vector in a storage area of the present server. By this processing, the present system completely automates information collection work that has relied on human visual confirmation. The present system brings about a technical effect of dramatically improving the accuracy of data input. The present system discovers a deficiency or an inconsistency in the input data at an early stage. The present system is extremely useful in use cases such as a preliminary investigation of a construction site and an assessment work of a real estate property.

The project determination unit operates on the server and analyzes the project information using generative AI. The generative AI is configured by combining a plurality of AI technologies such as a natural language processing model, an image recognition model, a machine learning model, and a deep learning model. For example, regarding the drawing data and the site photograph, an image recognition AI automatically analyzes the contents and extracts a building structure, presence or absence of an obstacle, a floor size, an installable space, and the like. Regarding the text information, a natural language processing AI detects an omission or an inconsistency of information, and automatically determines an information deficiency such as “drawing data is not attached”, “person-in-charge information is not input”, or “number of surrounding base stations is unknown”. Furthermore, the generative AI receives a plurality of elements such as a building name, a floor, the number of surrounding base stations, a past countermeasure history, a radio wave countermeasure status of surrounding buildings, a radio wave intensity, a floor height, a customer attribute, request source department information, special circumstances of the site, and a customer request as inputs, searches a past radio wave countermeasure history database for past similar projects, and performs pattern recognition and statistical inference. For example, by referring to a history such as “resolved by installing an amplifier on the 6th floor of the same building in the past”, “many similar cases exist with 3 surrounding base stations”, “resolved by installing a small base station in the past with the same customer attribute”, or “there is a case where the site was an underground floor and a special amplifier was required”, it is determined with high accuracy whether or not the project is solvable by a standard countermeasure. Specifically, the present project determination unit includes a large-scale language model based on a transformer architecture. The present project determination unit receives the multimodal feature vector as input data. The present input data is, for example, a 512-dimensional numerical vector. The present input data includes an image tensor indicating the building structure. The present input data includes a text embedding vector indicating the customer request. The present project determination unit comprehensively analyzes these input data using a self-attention mechanism. The present project determination unit executes inference using a weight parameter pre-trained with past project history data. The present project determination unit outputs probability distribution data indicating a success probability of each countermeasure method as an output. The present output data is an array of numerical values such as 0.85 for amplifier installation, 0.12 for small base station installation, and 0.03 for new base station installation, for example. The present project determination unit determines an optimal countermeasure method based on this probability distribution data. The present project determination unit calculates a reliability score of the determined countermeasure method. The present project determination unit passes this reliability score to subsequent classification processing. By this processing, the present system eliminates an ambiguous judgment based on a human rule of thumb. The present system exhibits a technical effect of realizing an objective and highly accurate determination through complex pattern recognition in a high-dimensional space. The present system is applicable to use cases such as optimization work of a communication network and preventive maintenance work of infrastructure equipment.

The project determination unit classifies the project into a “simple project” and a “complex project” based on an inference result of the generative AI. For example, the project is classified as the simple project in a case where it is determined that installation of an amplifier or a small base station is sufficient, and is classified as the complex project in a case where it is determined that installation of a special amplifier or a new base station, or a complex site investigation is required. The generative AI automatically extracts a pattern such as “the same countermeasure was effective a plurality of times in the past with the same building, the same floor, the same number of base stations, and the same customer attribute”, for example, and also records a basis for the determination. Furthermore, the AI also automatically performs priority determination of the project, extracts a project with high priority by taking into consideration conditions such as “the customer is a large corporation and the radio wave intensity at the site is extremely low”, “there is a request for urgent handling from the customer”, and “complaints have frequently occurred from the same customer in the past”, and supports optimal allocation of human resources. Specifically, the present project determination unit executes classification processing using a machine learning algorithm such as a support vector machine or a random forest. The present project determination unit receives the reliability score and the probability distribution data calculated in the preceding stage as inputs. The present project determination unit plots the input data on a multidimensional feature space. The present project determination unit classifies the project into the simple project and the complex project using a pre-trained decision boundary. The present project determination unit outputs a binary label indicating a classification result. The present output data is, for example, a numerical value of 0 indicating the simple project or 1 indicating the complex project. The present project determination unit simultaneously calculates a priority score. The present priority score is output as a continuous value from 0.0 to 1.0. The present project determination unit calculates the priority score by weighting and adding an attribute vector of the customer and numerical data of the radio wave intensity. The present project determination unit compares the calculated priority score with a threshold value. The present project determination unit registers a project whose priority score exceeds the threshold value in a priority processing queue. By this processing, the present system automates triage of projects. The present system brings about a technical effect of optimizing allocation of computational resources and human resources. The present system is extremely effective in use cases such as restoration work at the time of a disaster requiring urgent handling and communication countermeasures at the time of a large-scale event.

The project processing unit operates on the server and automatically executes processing in accordance with a determination result of the project determination unit. In a case of the simple project, the generative AI automates selection of a construction company and ordering processing. In selecting the construction company, the generative AI comprehensively evaluates a plurality of parameters such as past records (for example, “10 past records in the same building”, “abundant experience in installing similar equipment”, or the like), supported areas (for example, “supports entire Tokyo area”, “supports only Kanto region”, or the like), availability statuses (for example, “can handle within this week”, “cannot handle until next month or later”, or the like), construction periods (for example, “standard construction period of 2 weeks”, “can handle short delivery time”, or the like), costs (for example, “standard price”, “surcharge”, or the like), quality evaluations (for example, “high past customer evaluation”, “low complaint occurrence rate”, or the like), a past trouble history (for example, “many construction period delays”, “there was a construction mistake”, or the like), and evaluations from customers (for example, “polite handling”, “prompt reporting”, or the like) of construction companies, and automatically selects an optimal construction company. For example, the AI analyzes information such as “construction company A has 10 past records in the same building, has a short construction period, and has a high evaluation” and “construction company B is currently available but had a delay in the past”, and determines the optimal construction company. Ordering data is automatically generated and automatically transmitted to a system of the construction company. For example, order contents such as “7th floor of building A, amplifier installation, drawing attached, construction period within 2 weeks, person in charge Mr. B, desire for night construction” are automatically transmitted to the construction company. Furthermore, after ordering to the construction company, the AI also automatically performs progress management, and functions such as “automatically collecting a progress report from the construction company”, “automatically detecting a construction completion report”, and “automatically issuing an alert in a case where a delay occurs” can also be implemented, for example. Specifically, the present project processing unit executes selection processing of the construction company using a reinforcement learning algorithm. The present project processing unit receives a profile vector indicating characteristics of each construction company as an input. The present profile vector includes numerical data such as the number of past construction records, an average construction period, and a quality evaluation score. The present project processing unit calculates a cosine similarity between a request vector indicating required specifications of the project and the profile vector. The present project processing unit selects a construction company having the highest similarity as an optimal candidate. The present project processing unit generates ordering data for the selected construction company. The present ordering data is output as structured data in a JSON format. The present ordering data includes key-value pairs such as construction contents, a desired construction period, and a URL of an attached file. The present project processing unit transmits the generated ordering data to the system of the construction company via a secure API. The present project processing unit receives a status code after completion of the transmission. The present project processing unit updates a project state in the database based on the status code. By this processing, the present system completely eliminates conventional manual ordering work. The present system exhibits technical effects of reducing ordering mistakes and dramatically improving a processing speed. The present system is widely applicable to use cases such as supply chain management and contractor selection work in a logistics and delivery industry.

On the other hand, in a case of the complex project, the generative AI automatically assigns an optimal main person in charge in consideration of expertise (for example, “expert in amplifier installation”, “experienced technician in base station installation”, or the like), a work load (for example, “number of projects currently being handled”, “overtime hours”, or the like), a past handling history (for example, “handling experience in the same building”, “past record of similar complex projects”, or the like), a supportable area (for example, “in charge of Kanto region”, “nationwide support”, or the like), suitability of a technical field (for example, “specialized in indoor radio wave countermeasures”, “specialized in outdoor base stations”, or the like), and the like of the main person in charge. For example, the AI analyzes information such as “main person in charge C has handled many similar complex projects in the past and has a low current work load” and “main person in charge D is excluded from assignment because of a different technical field”, and selects the optimal main person in charge. Project contents are automatically notified to a terminal of the main person in charge, and the main person in charge proceeds with a detailed site investigation, a request to a technical department, consideration of installation of a special amplifier or a new base station, and the like. For example, it is possible to cope with a complex business flow such as “adjustment of a site visit schedule for a site investigation”, “meeting with a technical department”, “consideration of specifications of a special amplifier”, and “administrative procedure for installing a new base station”. Specifically, the present project processing unit executes assignment processing of the main person in charge using a graph neural network. The present project processing unit expresses a skill set and a current work load of a technician as nodes. The present project processing unit expresses a required skill of the project as another node. The present project processing unit generates graph structure data in which relationships between nodes are defined as edges. The present project processing unit inputs this graph structure data into the graph neural network. The present project processing unit outputs a suitability score of each technician node. The present suitability score is a floating-point number from 0.0 to 1.0. The present project processing unit selects a technician having the highest suitability score as the main person in charge. The present project processing unit generates an identifier of the selected main person in charge as output data. The present project processing unit acquires contact information from an internal system using this identifier. The present project processing unit automatically transmits a notification message to the acquired contact information. By this processing, the present system instantaneously executes optimal resource allocation satisfying complex constraint conditions. The present system brings about a technical effect of eliminating personalization of work and improving productivity of the entire organization. The present system is applicable to use cases such as failure handling of an IT system requiring advanced expertise and assignment of a medical specialist in a medical institution.

In addition, in a case where an information deficiency of the project information is determined, the generative AI automatically extracts deficiency contents, and returns a specific correction instruction such as “drawing data is insufficient”, “person-in-charge information is not input”, “description of the number of surrounding base stations is unclear”, “site photograph is unclear”, or “customer request is not filled in” to the terminal, for example. The applicant can make a correction on the terminal and reapply. For example, handling such as “reattaching a drawing file”, “inputting person-in-charge information”, and “retaking and uploading a site photograph” is possible. Specifically, the present generative AI executes a rule-based verification algorithm and a deep learning-based anomaly detection algorithm in parallel on the input project information. The present generative AI determines presence or absence of input of an essential item by a logical operation. The present generative AI evaluates semantic consistency of the input text data using a context embedding vector. The present generative AI applies an image quality evaluation model to the image data and calculates numerical values of resolution and contrast. The present generative AI integrates these evaluation results and outputs a flag indicating presence or absence of a deficiency. In a case where a deficiency is detected, the present generative AI generates an array of error codes indicating a type and a location of the deficiency. The present generative AI inputs this error code array into a natural language generation model. The present generative AI outputs a specific correction instruction text that is easy for a user to understand. The present output text is a character string such as “Please re-upload the drawing data because its resolution is low”, for example. The present generative AI transmits this text to the terminal and causes it to be displayed as a warning on a user interface. By this processing, the present system ensures quality of the input data at a system entrance. The present system exhibits a technical effect of dramatically reducing an error occurrence rate in subsequent processing. The present system is extremely useful in use cases such as an electronic application system to an administrative agency and an account opening procedure of a financial institution.

Furthermore, the generative AI automatically records and accumulates a processing history, a determination basis, a construction company selection reason, a main person in charge assignment reason, a progress status, feedback from a customer, a construction completion report, a trouble occurrence history, and the like for each project, and can also utilize them for future re-training of an AI model, business improvement, and audit response. For example, trend analysis such as “all projects on the same building and the same floor in the past year were resolved by installing an amplifier”, “a construction period delay rate of construction company A is on a downward trend”, and “customer satisfaction is high in projects handled by main person in charge C” is also possible. Furthermore, the AI can also automatically perform future project occurrence prediction, risk analysis, optimization proposal of a business process, and the like using these history data. Specifically, the present generative AI stores the accumulated history data in a time-series database. The present generative AI periodically activates batch processing and executes re-training of a model using the history data. The present generative AI calculates an error between a past prediction result and an actual business result using a loss function. The present generative AI updates a weight parameter of a neural network using an error backpropagation method. The present generative AI performs optimization using a gradient descent algorithm. The present generative AI executes a time-series prediction model that predicts the number of future project occurrences using a trained model. The present time-series prediction model receives a past project occurrence frequency and a seasonal variation factor as an input tensor. The present time-series prediction model outputs a numerical array indicating the expected number of projects for each week for the next one month. The present generative AI performs pre-allocation of necessary computational resources based on this prediction data. By this processing, the present system autonomously adapts to an environmental change. The present system brings about a technical effect of always maintaining processing performance of the system in an optimal state. The present system is widely applicable to use cases such as call volume prediction in a call center and demand prediction in a retail industry.

In this way, the automatic processing system for radio wave countermeasure projects of the present invention realizes each unit of the project information acquisition unit, the project determination unit, and the project processing unit on the server, and the terminal is configured to mainly bear user interface functions such as information input, notification, correction, confirmation, and approval, whereby a series of business processes from project reception to determination, assignment, ordering, notification, progress management, and history management can be automated at high speed and with high accuracy using the generative AI. For example, it becomes possible to shorten a period from project reception to ordering to a construction company from several days in the past to within several hours, and effective utilization of human resources, reduction of business costs, improvement of customer satisfaction, and standardization and quality improvement of business processes can be realized. Furthermore, by utilizing the generative AI, it is possible to flexibly cope with various patterns and exceptions for each project, and future business expansion and application to other fields become easy. For example, application to a wide range of fields is possible, such as not only indoor radio wave countermeasures but also new establishment and reinforcement of outdoor base stations, emergency handling at the time of a disaster, and deployment to public facilities and transportation infrastructure. In addition, by utilizing an automatic learning function by AI, accuracy and efficiency of project processing continuously improve, and sophistication and autonomization of the entire business can be realized. Specifically, the present system implements each processing module as a microservice architecture. The present system dynamically controls scaling of each module using a container orchestration technology. The present system automatically increases or decreases the number of instances of the project determination unit and the project processing unit in accordance with an inflow amount of projects. The present system distributes a load of the entire system and eliminates a single point of failure. The present system executes inference processing of the generative AI on a dedicated tensor processing unit. The present system shortens a calculation time required for inference to a millisecond unit. The present system completes a series of data pipelines from vectorization of input data to generation of final ordering data on a memory. The present system eliminates a bottleneck caused by disk IO. The present system achieves advanced automation that was impossible to realize with a conventional computer system by close cooperation between these hardware and software. The present system exhibits technical effects of overwhelming improvement in processing speed and significant reduction in operation cost. The present system provides an innovative solution in use cases such as integrated infrastructure management in a smart city and automatic control of a production line in a large-scale manufacturing industry.

### System Configuration

The system according to the present embodiment comprises a project information acquisition unit, a project database management unit, a generative AI analysis unit, a project determination unit, a project classification unit, a construction company selection unit, an ordering processing unit, a main person-in-charge assignment unit, a progress management unit, a notification/feedback unit, a history management/learning unit, and a user interface unit.

The project information acquisition unit has a function of receiving diverse project information such as a building name, a building address, a building type, a floor number, a floor area, the number of surrounding base stations, a model of a surrounding base station, drawing data, a site photograph, person-in-charge information, a request source department, a customer attribute, a radio wave intensity measurement value, a desired handling time, presence or absence of a past countermeasure history, special circumstances of a site, and a request matter from a customer from a terminal such as a personal computer, a tablet, or a smartphone used by the customer or a sales representative, and transmitting these to a server. For example, in a case where the sales representative inputs information such as “the 7th floor of an office building A in Tokyo, three surrounding base stations, a site photograph and a drawing file attached, a person in charge is Mr. B, a request source is a corporate sales department, a customer attribute is a large-scale corporation, a radio wave intensity of the site is −90 dBm, handling desired within one month, an underground floor with many shielding objects, and night construction desired”, the project information acquisition unit accurately receives all of this information and links it to each unit on the server side. Furthermore, the project information acquisition unit also includes functions for format conversion of input information, file encryption, data normalization, and real-time input assistance, and is responsible for improving the quality of the input information, for example, by performing automatic conversion in a case where a file format of the drawing data is different, and displaying a warning in a case where image quality of the site photograph is low. Specifically, the project information acquisition unit receives a data stream transmitted from the terminal using an asynchronous communication protocol. The project information acquisition unit divides the received data stream in units of packets and temporarily stores them in a buffer area on a memory. The project information acquisition unit executes a data format determination algorithm and analyzes an extension and header information of each file. The project information acquisition unit applies preprocessing such as a noise removal filter and edge enhancement processing to image data. The project information acquisition unit executes morphological analysis on text data and deletes unnecessary symbols and stop words. The project information acquisition unit converts the preprocessed data into a structured JSON object. The project information acquisition unit transmits this JSON object to a message queuing system. By this processing, the system normalizes input data of diverse formats into a unified data model. The system brings about a technical effect of dramatically improving calculation efficiency in subsequent AI analysis processing. The system is applicable to use cases such as integrated management of electronic medical records in medical institutions and sensor data collection from a plurality of bases.

The project database management unit has a function of organizing the acquired project information by time series or attribute, and storing and managing it in a database. For example, it classifies data by building, by floor, by customer, and by progress status of a project, and efficiently manages past project histories, ongoing projects, completed projects, returned projects, and the like. Furthermore, the project database management unit also performs storage of large-capacity files such as drawing data and site photographs, data backup, access authority management, encrypted storage of data, and the like, and reduces risks of information leakage and data loss. For example, by immediately searching for a history of projects that occurred in the same building in the past and providing it to the AI analysis unit, rapid extraction of similar projects is enabled. Specifically, the project database management unit adopts a hybrid storage architecture combining a relational database and a NoSQL database. The project database management unit stores structured data in a table of the relational database. The project database management unit stores unstructured data such as images and drawings in an object storage. The project database management unit generates a unique hash value for each data and assigns it as an index. The project database management unit incorporates a vector search engine. The project database management unit manages a feature vector of a project using a multidimensional index structure. The project database management unit searches for a past project vector closest to a query vector at high speed using an approximate nearest neighbor search algorithm. By this processing, the system specifies a similar project in units of milliseconds from an enormous amount of history data on a scale of millions of cases. The system exhibits a technical effect of reducing data search latency to the utmost limit. The system is extremely effective in use cases such as a prior art search system for patent documents and a product recommendation engine in electronic commerce.

The generative AI analysis unit operates on the server, receives diverse data such as project information, past project histories, site photographs, drawing data, and customer requests as input, and performs analysis by combining a plurality of AI technologies such as a natural language processing model, an image recognition model, a machine learning model, and a deep learning model. For example, regarding the drawing data and the site photograph, an image recognition AI automatically analyzes the contents and extracts a building structure, presence or absence of a shielding object, a floor size, an installable space, and the like. Regarding text information, a natural language processing AI detects omissions and inconsistencies of information, and automatically determines information deficiency such as “drawing data is not attached”, “person-in-charge information is not input”, and “the number of surrounding base stations is unknown”. Furthermore, the generative AI analysis unit receives a plurality of elements such as a building name, a floor, the number of surrounding base stations, a past countermeasure history, a radio wave countermeasure status of surrounding buildings, a radio wave intensity, a floor height, a customer attribute, a request source department, special circumstances of a site, and a customer request as input, searches for past similar projects from the database, and performs pattern recognition and statistical inference. For example, by referring to histories such as “resolved by installing an amplifier on the 6th floor of the same building in the past”, “there are many similar cases with three surrounding base stations”, “resolved by installing a small base station in the past with the same customer attribute”, and “there is a case where the site was an underground floor and a special amplifier was required”, it determines with high accuracy whether or not the project is solvable by a standard countermeasure. As a specific example of a prompt sentence to be read into the generative AI analysis unit, there is given “Based on the following project information, search for past similar projects and infer an optimal radio wave countermeasure method. Project information: building name=office building A, floor=7th floor, number of surrounding base stations=3, site photograph attached, drawing file attached, customer attribute=large-scale corporation, radio wave intensity of site=−90 dBm, special circumstances=underground floor/many shielding objects, request=night construction desired”. Specifically, the generative AI analysis unit executes a transformer model equipped with a multi-layer self-attention mechanism. The generative AI analysis unit tokenizes the input project information and generates a token embedding vector. The generative AI analysis unit adds positional encoding to construct an input tensor. This input tensor is, for example, a third-order tensor having a batch size, a sequence length, and the number of dimensions of a hidden layer. The generative AI analysis unit forward-propagates this input tensor to each layer of a neural network. The generative AI analysis unit applies a vision transformer model to image data and extracts a feature vector for each image patch. The generative AI analysis unit fuses a text feature and an image feature using a cross-attention mechanism. The generative AI analysis unit inputs the fused feature vector to a fully connected layer. The generative AI analysis unit generates an array of logit values indicating a degree of conformity of each countermeasure method as a final output. The generative AI analysis unit applies a softmax function to convert the logit values into a probability distribution. This output data is numerical data such as an amplifier installation probability of 0.88 and a small base station installation probability of 0.09, for example. By this processing, the system integrally interprets heterogeneous data and discovers a hidden correlation that is difficult for a human to notice. The system brings about technical effects of improving analysis accuracy and ensuring objectivity of determination. The system is widely applicable to use cases such as surrounding environment recognition in an autonomous driving vehicle and a medical image diagnosis support system.

The project determination unit automatically determines validity of the project information and excess or deficiency of information based on an analysis result of the generative AI analysis unit, and classifies whether the project is a simple project solvable by installing a standard amplifier or a small base station, or a complex project requiring installation of a special amplifier, a new base station, or the like. For example, in a case where information deficiency such as “drawing data is not attached”, “person-in-charge information is not input”, or “site photograph is unclear” is detected, it automatically transmits a return notification to an applicant. The project determination unit also records an inference basis of the generative AI, automatically extracts a pattern such as “the same countermeasure was effective a plurality of times in the past with the same building, the same floor, the same number of base stations, and the same customer attribute”, for example, and ensures transparency of determination. Furthermore, it also automatically performs priority determination of the project, and extracts a project with high priority in consideration of conditions such as “the customer is a large-scale corporation and the radio wave intensity of the site is extremely low”, “there is a request for urgent handling from the customer”, and “claims have frequently occurred from the same customer in the past”. Specifically, the project determination unit receives the probability distribution data and the feature vector output from the generative AI analysis unit as input. The project determination unit applies a classification rule using a decision tree algorithm. The project determination unit determines whether or not a maximum value of the probability distribution exceeds a predetermined threshold value. In a case where the maximum value exceeds the threshold value, the project determination unit outputs the countermeasure method as a confirmed result. In a case where the maximum value falls below the threshold value, the project determination unit flags the project as a complex project. The project determination unit simultaneously executes a priority calculation algorithm. The project determination unit constructs an input vector having an importance score of the customer attribute, a reciprocal of the radio wave intensity, and the number of past claims as elements. The project determination unit calculates an inner product of this input vector and a preset weight vector. The project determination unit inputs the inner product result to a sigmoid function and outputs a priority score normalized to a range from 0 to 1. This output data is a numerical value indicating a high priority such as 0.92, for example. The project determination unit writes this priority score into the database as metadata of the project. By this processing, the system quantitatively evaluates importance of the project and dynamically optimizes a processing order. The system exhibits a technical effect of most effectively allocating limited calculation resources. The system is applicable to use cases such as a fraudulent transaction detection system in a financial institution and triage of threat alerts in network security.

The project classification unit classifies the project into a simple project and a complex project based on a determination result of the project determination unit, and automatically branches a subsequent processing flow. For example, the project is classified as the simple project in a case where it is determined that installation of an amplifier or a small base station is sufficient, and is classified as the complex project in a case where it is determined that installation of a special amplifier or a new base station, or a complex site investigation is required. The project classification unit also automatically determines a processing priority and resource allocation for each project, and aims to optimize human resources. Specifically, the project classification unit receives the classification flag and the priority score output from the project determination unit as input. The project classification unit manages a plurality of processing queues constructed on a memory. In a case where the classification flag indicates the simple project, the project classification unit enqueues a data pointer of the corresponding project into a queue for automatic ordering processing. In a case where the classification flag indicates the complex project, the project classification unit enqueues the data pointer of the corresponding project into a queue for expert technician assignment. The project classification unit applies a priority queuing algorithm based on the priority score at the time of enqueueing. The project classification unit dynamically reorganizes a data structure such that a project with a high priority score is arranged at the head of the queue. The project classification unit constantly monitors a length of each queue. In a case where projects stagnate in a specific queue, the project classification unit issues a warning signal to a system administrator. By this processing, the system automatically selects an optimal processing path according to a nature of the project. The system brings about a technical effect of maximizing processing throughput of the entire system and preventing occurrence of a bottleneck. The system is extremely useful in use cases such as task scheduling in a cloud computing environment and an incoming call distribution system in a large-scale call center.

In a case where the project is determined to be the simple project, the construction company selection unit automatically selects an optimal construction company by comprehensively evaluating a plurality of parameters such as past records, supported areas, availability statuses, construction periods, costs, quality evaluations, a past trouble history, and evaluations from customers of construction companies using the generative AI. For example, the AI analyzes information such as “construction company A has a past record of 10 cases in the same building, has a short construction period, and has a high evaluation” and “construction company B currently has availability but had a delay in the past”, and determines the optimal construction company. The construction company selection unit also records a selection reason and a past selection history, and utilizes them for future business improvement and retraining of an AI model. Specifically, the construction company selection unit executes selection processing using a multi-objective optimization algorithm. The construction company selection unit acquires attribute data of each construction company from the database and constructs a candidate matrix. This candidate matrix is a two-dimensional numerical array in which rows indicate construction companies and columns indicate evaluation indices (cost, construction period, quality score, etc.). The construction company selection unit sets a weighting coefficient vector for each evaluation index based on requirement conditions of the project. The construction company selection unit calculates a matrix product of the candidate matrix and the weighting coefficient vector. The construction company selection unit calculates a comprehensive evaluation score of each construction company. The construction company selection unit specifies a construction company having the highest comprehensive evaluation score as an optimal candidate. The construction company selection unit generates an ID of the specified construction company as output data. The construction company selection unit analyzes a contribution degree of each index in this selection process using explainable AI technology. The construction company selection unit stores an analysis result in a storage as log data. By this processing, the system mathematically processes a plurality of conflicting conditions and derives an optimal solution. The system exhibits a technical effect of realizing fair and rational selection eliminating human bias. The system is applicable to use cases such as an automatic bidding system for public works and a real-time bidding platform for online advertisements.

The ordering processing unit automatically generates ordering data for the construction company selected by the construction company selection unit, and automatically transmits it to a system of the construction company. For example, order contents such as “7th floor of building A, amplifier installation, drawing attached, construction period within 2 weeks, person in charge Mr. B, night construction desired” are automatically transmitted. The ordering processing unit is also responsible for progress management and delivery date management after ordering, automatic collection of progress reports from the construction company, automatic detection of construction completion reports, alert transmission when a delay occurs, and the like. Specifically, the ordering processing unit generates structured ordering data using a template engine. The ordering processing unit extracts necessary field values from the project database and dynamically constructs a payload in XML or JSON format. The ordering processing unit adds a digital signature to the constructed payload to prevent data falsification. The ordering processing unit transmits the payload to an external system of the construction company via a RESTful API endpoint. The ordering processing unit implements timeout processing and a retry mechanism at the time of transmission. In a case where a communication error occurs, the ordering processing unit controls a retransmission interval using an exponential backoff algorithm. The ordering processing unit receives an HTTP status code 200 indicating receipt confirmation from the construction company system. The ordering processing unit updates a project status in the database to “ordered” using this status code as a trigger. The ordering processing unit periodically executes polling processing and acquires progress data from the construction company. By this processing, the system reliably and safely executes data linkage between heterogeneous systems. The system brings about a technical effect of guaranteeing transaction integrity and preventing business stagnation. The system is extremely effective in use cases such as payment gateway linkage in electronic commerce and an automatic inventory replenishment system in a supply chain.

In a case where the project is determined to be the complex project, the main person-in-charge assignment unit automatically assigns an optimal main person in charge in consideration of expertise, a work load, a past handling history, a supportable area, suitability of a technical field, and the like of the main person in charge. For example, the AI analyzes information such as “main person in charge C has handled many similar complex projects in the past and has a low current work load” and “main person in charge D is excluded from assignment because of a different technical field”, and selects the optimal main person in charge. The main person-in-charge assignment unit automatically notifies project contents to a terminal of the main person in charge, and the main person in charge proceeds with a detailed site investigation, a request to a technical department, consideration of installation of a special amplifier or a new base station, and the like. Specifically, the main person-in-charge assignment unit searches for an optimal person in charge using a constraint satisfaction problem solving algorithm. The main person-in-charge assignment unit expands current task statuses, possessed skill sets, and work schedules of all technicians on a memory as a multidimensional array. The main person-in-charge assignment unit calculates a logical product between a required skill of the project and a possessed skill of a technician, and generates a candidate list satisfying a skill requirement. The main person-in-charge assignment unit applies a penalty function based on a current work load score to this candidate list. The main person-in-charge assignment unit determines a technician having a minimum penalty score as an optimal person in charge. The main person-in-charge assignment unit outputs an ID of the determined technician. The main person-in-charge assignment unit transmits a request to a push notification server using this ID. The push notification server transmits an encrypted notification payload including project details to a mobile terminal of the corresponding technician. By this processing, the system solves a resource allocation problem under complex constraint conditions within polynomial time. The system exhibits a technical effect of preventing business concentration on a specific individual and leveling an operation rate of the entire organization. The system is widely applicable to use cases such as an automatic dispatch system for taxis and driver assignment for an on-demand delivery service.

The progress management unit monitors the progress status of the project in real time, automatically collects progress reports from the construction company and the main person in charge, and visualizes the progress status. For example, it records the progress of each process such as “start of construction”, “completion of site investigation”, “completion of amplifier installation”, and “construction completion report”, and automatically issues an alert in a case where a delay occurs. The progress management unit also automatically performs progress notification to the customer and the sales representative, contributing to improvement of customer satisfaction. Specifically, the progress management unit adopts an event-driven architecture to manage state transitions. The progress management unit asynchronously receives a status update event transmitted from an external system or a terminal via a message broker. The progress management unit extracts a project ID and a new status code from the received event data. The progress management unit updates a status value while performing exclusive control on a corresponding record in a database. The progress management unit records a time stamp simultaneously with the update processing. The progress management unit calculates a difference between a scheduled date and time for each predefined milestone and the actual time stamp. In a case where this difference exceeds an allowable threshold, the progress management unit generates an alert event indicating occurrence of a delay. The progress management unit inputs this alert event into a rule engine to determine an appropriate notification destination and notification means. The progress management unit automatically transmits a message to the determined notification destination using an e-mail or an SMS. By this processing, the system accurately tracks statuses of a large number of projects operating in parallel in real time. The system brings about a technical effect of detecting a process delay at an early stage and enabling a prompt corrective measure. The system is applicable to use cases such as a project management tool in large-scale software development and a process management system in a manufacturing industry.

The notification/feedback unit automatically generates notifications and feedback necessary at each processing stage of the project, and transmits them to related parties such as the customer, the sales representative, the construction company, and the main person in charge. For example, it automatically generates various notifications such as “project reception completion notification”, “return notification due to information deficiency”, “order notification to construction company”, “construction completion notification”, and “customer questionnaire request”. The notification/feedback unit also collects feedback and questionnaire results from the customer, and utilizes them for re-learning of the AI model and business improvement. Specifically, the notification/feedback unit receives a state transition trigger from each processing unit via an event-driven messaging queue. The notification/feedback unit activates a natural language generation model based on the received state transition trigger. The natural language generation model is a large language model based on a transformer architecture. The notification/feedback unit converts attribute data and a status code of the project into a multidimensional vector. The notification/feedback unit inputs the multidimensional vector into the natural language generation model. The natural language generation model generates a notification text optimized for a context from the input vector. For example, an input to the natural language generation model is tensor data including a project identifier, a customer attribute vector, and a progress status flag. An output from the natural language generation model is a generated text character string and a transmission priority score. In a case where the output transmission priority score exceeds a predetermined threshold, the notification/feedback unit transmits the notification via a communication protocol for immediate transmission. The notification/feedback unit analyzes text data of the questionnaire result returned from the customer terminal using a natural language processing model. The natural language processing model extracts an emotion score and a keyword vector from the text data. The notification/feedback unit stores the extracted emotion score and keyword vector in a database as training data. The system updates weight parameters of neural networks of the project determination unit and a construction company selection unit by an error backpropagation method using the accumulated training data. Thereby, the system realizes optimization of notifications and continuous improvement of the models without human intervention. With this configuration, the system exhibits a technical effect of reducing waste of a communication band and improving processing efficiency of the entire system. The present technology is applicable to a use of minimizing an information transmission delay among related parties in a maintenance management system for a large-scale communication infrastructure.

The history management/learning unit automatically records and accumulates a processing history, a determination basis, a construction company selection reason, a main person in charge assignment reason, a progress status, feedback from the customer, a construction completion report, a trouble occurrence history, and the like for each project, and utilizes them for future re-learning of the AI model, business improvement, and audit response. For example, trend analysis such as “all projects on the same floor of the same building in the past year were solved by installing an amplifier”, “the construction period delay rate of the construction company A is on a downward trend”, and “customer satisfaction is high in projects handled by the main person in charge C” is also possible. The history management/learning unit utilizes an automatic learning function by AI to continuously improve accuracy and efficiency of project processing. Specifically, the history management/learning unit includes a time-series data store constructed on a distributed database system. The history management/learning unit collects structured data and unstructured data output from each processing unit in real time. The history management/learning unit maps the collected data to a high-dimensional feature space and stores it in a vector database. The history management/learning unit periodically executes batch processing and performs re-learning of the machine learning model using the accumulated vector data. In this re-learning process, the history management/learning unit calculates an error between a past determination result and an actual construction result as a loss function. The history management/learning unit optimizes weights of the neural network using a stochastic gradient descent method. The history management/learning unit executes a clustering algorithm for trend analysis. The clustering algorithm groups performance indicators of construction companies in a multidimensional space, for example. Input data to the history management/learning unit is a numerical vector including a processing time, a cost, and a customer satisfaction score for each project. Output data from the history management/learning unit is a performance prediction score of each construction company or person in charge, and a parameter set for updating the model. The system utilizes the output prediction score as a weighting coefficient in the subsequent construction company selection unit. Thereby, unlike a static rule-based system, the system realizes a self-evolving architecture that dynamically adapts to environmental changes. With this configuration, the system brings about technical effects of speeding up data retrieval and continuously improving prediction accuracy. The present technology is suitably applied to a dynamically fluctuating resource allocation problem and a large-scale field service management system.

The user interface unit operates on the terminal and provides an operation screen for the customer, the sales representative, the main person in charge, a person in charge of the construction company, and the like to perform input of project information, progress confirmation, notification reception, feedback input, and the like. For example, it includes various screens such as an input screen for project information, an upload screen for drawings and site photographs, a timeline display of a progress status, a list display of a notification history, and a feedback input form. The user interface unit also implements an input assistance function, an error check function, a real-time notification function, and the like to enhance user convenience. Specifically, the user interface unit includes a dynamic rendering engine executed on a processor of a client terminal. The user interface unit receives structured data in a JSON format transmitted from a server side. The user interface unit constructs a virtual DOM tree based on the received data, and redraws only a difference of the screen. The user interface unit executes a lightweight convolutional neural network operating on a client side at the time of image upload. The convolutional neural network receives an uploaded image tensor as an input. The convolutional neural network analyzes a resolution, brightness, and a noise level of the image. An output from the convolutional neural network is an image quality score and bounding box coordinates of an unclear region. In a case where the output image quality score falls below a predetermined threshold, the user interface unit suspends transmission to the server and draws a warning prompting the user to retake a photograph on the screen. The user interface unit executes real-time input completion processing using a natural language processing model in a text field of an input form. The input completion processing inputs a keystroke history of the user as a time-series array, and outputs a probability distribution of a word to be input next. The user interface unit displays a word with the highest probability on the screen as a suggestion. Thereby, the system prevents transmission of invalid data to the server in advance, and significantly reduces consumption of a network band. With this configuration, the system exhibits a technical effect of reducing a processing load on the server side and improving a response speed of the entire system. The present technology is applicable to a mobile application operating under a low-bandwidth communication environment and a data input system requiring real-time performance.

As described above, the system according to the present embodiment includes the project information acquisition unit, a project database management unit, a generative AI analysis unit, the project determination unit, a project classification unit, the construction company selection unit, the ordering processing unit, a main person in charge assignment unit, the progress management unit, the notification/feedback unit, the history management/learning unit, and the user interface unit, and each unit cooperates to be able to automate and optimize a series of business processes from reception of a radio wave countermeasure project to determination, classification, assignment, ordering, progress management, history management, feedback collection, and AI learning. Specific examples of a prompt sentence to be read by the generative AI include “Based on the following project information, search for past similar projects and infer an optimal radio wave countermeasure method. Project information: building name=office building A, floor=7th floor, number of surrounding base stations=3, site photograph attached, drawing file attached, customer attribute=large corporation, radio wave intensity at site=−90 dBm, special circumstances=underground floor/many shielding objects, request=night construction desired” and “From among the following construction company candidates, comprehensively evaluate past records, supported areas, availability statuses, construction periods, costs, quality evaluations, trouble histories, and customer evaluations, and select an optimal construction company. Candidates: construction company A, construction company B, construction company C”. Specifically, the system containerizes each processing unit as a plurality of independent microservices, and executes them in parallel on an orchestration platform. The system performs data communication between the microservices using a high-speed remote procedure call protocol. The generative AI analysis unit converts the input prompt sentence into an integer token ID array by a tokenizer. The generative AI analysis unit inputs the token ID array into a transformer model including a multi-layer self-attention mechanism. The transformer model calculates a dependency relationship between the input tokens and generates a context vector. An output from the transformer model is a probability distribution of text tokens indicating the optimal radio wave countermeasure method, and a normalized score vector indicating a degree of conformity of each candidate construction company. For example, the output score vector is numerical data such as 0.85 for the construction company A, 0.12 for the construction company B, and 0.03 for the construction company C. The system inputs the output score vector into a subsequent sorting algorithm, and automatically selects a construction company having the highest score. The system executes transaction processing of the database based on the selection result, and updates an ordering status. Thereby, the system eliminates human subjective judgment and realizes objective and high-speed decision-making based on multidimensional evaluation indicators on a computer. With this configuration, the system exhibits a technical effect of integrating business logic involving complex conditional branching into a single inference process and optimizing consumption of calculation resources. The present technology is widely applicable to supply chain management that needs to simultaneously satisfy a plurality of constraint conditions, and a dynamic resource allocation system.

### Implementation Steps

Step 1: Input and Acquisition of Project Information The customer or the sales representative inputs diverse project information such as a building name, a building address, a building type, a floor number, a floor area, the number of surrounding base stations, a model of a surrounding base station, drawing data (PDF, CAD file, image file, or the like), a site photograph, person-in-charge information, a request source department, a customer attribute, a radio wave intensity measurement value, a desired handling time, presence or absence of a past countermeasure history, special circumstances of a site, and a request matter from the customer using a dedicated application or a web browser on the terminal, and such information is transmitted to the server via the project information acquisition unit. For example, there is a case where the sales representative inputs information such as “7th floor of office building A in Tokyo, 3 surrounding base stations, site photograph and drawing file attached, person in charge is Mr. B, request source is corporate sales department, customer attribute is large corporation, radio wave intensity at site is −90 dBm, handling within 1 month desired, underground floor with many shielding objects, night construction desired”. Specifically, the project information acquisition unit receives an HTTP request transmitted from the terminal, and extracts various data from a payload. The project information acquisition unit inputs the extracted text data into a natural language processing pipeline. The natural language processing pipeline includes a morphological analyzer and a named entity extraction model. The project information acquisition unit extracts entities such as “Tokyo”, “office building A”, and “−90 dBm” from the text data, and converts them into a structured JSON object. The project information acquisition unit expands the attached image file and PDF file on a memory as binary data. The project information acquisition unit inputs the binary data into a preprocessing module, performs resizing and normalization processing, and generates a multidimensional image tensor. For example, the input image tensor is RGB data of 3 channels with a resolution of 224×224. The project information acquisition unit inputs the generated image tensor into a convolutional neural network for feature extraction. An output from the convolutional neural network is a 512-dimensional feature vector expressing a visual feature in the image. The project information acquisition unit combines the structured text data and the extracted feature vector to generate an integrated project vector. The project information acquisition unit transfers the generated integrated project vector to the subsequent project database management unit and generative AI analysis unit. Thereby, the system makes it possible to handle unstructured data and structured data on a unified vector space. With this configuration, the system brings about a technical effect of dramatically improving calculation efficiency in a subsequent AI model and reducing latency of data processing. The present technology is applicable to an arbitrary information collection system handling multimodal data and an automated help desk system.
Step 2: Database Registration and Management of Project Information All the project information received from the project information acquisition unit is classified by building, by floor, by customer, and by progress status of the project by the project database management unit, and is stored and managed in a database. Large-capacity files such as drawing data and site photographs are also stored, and security measures such as data backup, access authority management, and encrypted storage are simultaneously implemented. Specifically, the project database management unit adopts a hybrid storage architecture combining a relational database and a distributed object storage. The project database management unit inserts the received integrated project vector and structured metadata into an indexed table of the relational database. The project database management unit divides binary data of large-capacity drawing data and site photographs into chunks, and performs parallel writing to the distributed object storage. The project database management unit applies a hash function to each chunk at the time of writing to generate a unique object ID. The project database management unit links the generated object ID to a corresponding record in the relational database. The project database management unit executes block encryption processing using an advanced encryption standard algorithm on all stored data. The project database management unit manages an encryption key with a dedicated hardware security module. The project database management unit executes asynchronous replication processing in the background among a plurality of geographically separated data centers in order to ensure data redundancy. When receiving an access request, the project database management unit verifies an authentication token of a request source, and collates it with a role-based access control list to determine an access authority. An input to the project database management unit is the integrated project vector and a binary data stream transferred from the project information acquisition unit. An output from the project database management unit is a status code indicating success of writing to the database and the generated unique record ID. The system utilizes the output record ID as a reference key for data in a subsequent processing step. Thereby, the system efficiently separates and manages large-capacity multimedia data and metadata requiring high-speed retrieval. With this configuration, the system exhibits a technical effect of realizing scalable data storage without reducing a retrieval speed of the database. The present technology is suitably applied to a large-scale electronic medical record system and a project management system in the construction and civil engineering industries.
Step 3: AI Analysis and Information Deficiency Determination of Project Information The generative AI analysis unit receives diverse data such as project information, a past project history, a site photograph, drawing data, and a customer request as an input, performs analysis by combining a plurality of AI technologies such as a natural language processing model, an image recognition model, a machine learning model, and a deep learning model, detects omission or inconsistency of information, and automatically determines information deficiency such as “drawing data is not attached”, “person-in-charge information is not input”, and “number of surrounding base stations is unknown”, for example. A specific example of a prompt sentence to be read by the generative AI includes “Based on the following project information, detect omission or inconsistency of input information, and point out if there is a deficiency. Project information: building name=office building A, floor=7th floor, number of surrounding base stations=3, site photograph attached, drawing file attached, customer attribute=large corporation, radio wave intensity at site=−90 dBm, special circumstances=underground floor/many shielding objects, request=night construction desired”. Specifically, the generative AI analysis unit includes an inference engine implementing a multimodal neural network architecture. The generative AI analysis unit combines the integrated project vector, the image feature vector, and a text prompt acquired from the project database management unit to construct a single input tensor. The generative AI analysis unit inputs the input tensor into a deficiency determination model including a multilayer perceptron and a self-attention mechanism. The deficiency determination model calculates a correlation between the input feature amounts, and detects omission of an essential item or a logical contradiction. For example, an input to the deficiency determination model is a 1280-dimensional tensor obtained by concatenating a 768-dimensional embedding vector extracted from text information and a 512-dimensional feature vector extracted from an image. An output from the deficiency determination model is an array of output values of a sigmoid function indicating a satisfaction probability for each essential item, and a latent vector for text generation indicating a reason for the deficiency. The generative AI analysis unit specifies an item whose output satisfaction probability falls below a preset threshold (for example, 0.95). The generative AI analysis unit generates a specific pointing-out message (for example, “model information of surrounding base station is insufficient”) using a decoder network based on the specified deficient item. The generative AI analysis unit transmits the generated pointing-out message together with an error flag to the subsequent notification/feedback unit. Thereby, the system highly detects context-dependent information inconsistency (for example, a case where it is described in text information that there is no shielding object even though a shielding object is shown in a site photograph) that cannot be found by a simple blank check. With this configuration, the system exhibits a technical effect of preventing rework in a subsequent process in advance and significantly shortening a processing time of the entire business process. The present technology is applicable to an automatic examination system for complex application documents and an automatic assessment system for insurance money.
Step 4: Similar Project Search and Countermeasure Method Inference by AI for Project Contents The generative AI analysis unit receives a plurality of elements such as a building name, a floor, the number of surrounding base stations, a past countermeasure history, a radio wave countermeasure status of surrounding buildings, a radio wave intensity, a floor height, a customer attribute, a request source department, special circumstances of a site, and a customer request as an input, searches for past similar projects from a database, performs pattern recognition and statistical inference, and determines whether or not the project is solvable by a standard countermeasure with high accuracy. A specific example of a prompt sentence to be read by the generative AI includes “Based on the following project information, search for past similar projects and infer an optimal radio wave countermeasure method. Project information: building name=office building A, floor=7th floor, number of surrounding base stations=3, site photograph attached, drawing file attached, customer attribute=large corporation, radio wave intensity at site=−90 dBm, special circumstances=underground floor/many shielding objects, request=night construction desired”. Specifically, the generative AI analysis unit includes a dedicated calculation module that executes a vector similarity search algorithm. The generative AI analysis unit converts the input project information into a multidimensional query vector. The generative AI analysis unit calculates a cosine similarity between the query vector and a past project vector group stored in the database. The generative AI analysis unit extracts top N past projects whose similarity exceeds a predetermined threshold. The generative AI analysis unit inputs countermeasure history data of the extracted past projects and current project information into a graph neural network. The graph neural network expresses a relationship between projects by nodes and edges, and infers a success probability of a countermeasure. For example, an input to the graph neural network is graph structure data including a node feature amount matrix and an adjacency matrix. An output from the graph neural network is an array of respective success probability scores for a plurality of countermeasure candidates (for example, small amplifier installation, directional antenna addition, new base station installation, and the like). The generative AI analysis unit selects a countermeasure candidate having the highest output success probability score as an optimal solution. The generative AI analysis unit determines whether or not the selected countermeasure candidate is included in a standard countermeasure list. The generative AI analysis unit outputs a determination result and the inferred countermeasure method to the subsequent project classification unit as structured data. Thereby, the system realizes objective and statistically supported countermeasure inference based on enormous past data without depending on human rules of thumb. With this configuration, the system exhibits a technical effect of reducing a risk of re-construction due to a mismatch of countermeasures and dramatically improving a countermeasure success rate. The present technology is widely applicable to a treatment method recommendation system based on past cases in a medical field and a repair procedure inference system for machine failure in a manufacturing industry.
Step 5: Project Classification and Priority Determination The project determination unit and a project classification unit classify whether the project is a simple project solvable by installing a standard amplifier or a small base station, or a complex project requiring installation of a special amplifier, a new base station, or the like, based on an inference result of a generative AI analysis unit, and further automatically determine a priority of the project in consideration of a customer attribute and requests, site urgency, a past claim history, and the like. For example, a project with a high priority is extracted in consideration of conditions such as “the customer is a large-scale corporation and the radio wave intensity at the site is extremely low” and “there is a request for urgent handling from the customer”. Specifically, the project classification unit executes a gradient boosting model based on decision tree ensemble learning. The project classification unit combines a success probability score of a countermeasure candidate output from the generative AI analysis unit and metadata of the project (radio wave intensity, customer attribute code, claim history flag, etc.) as a feature vector. The project classification unit inputs the feature vector into the gradient boosting model. The gradient boosting model calculates a complexity score and a priority score of the project by performing a weighted average of output results of a plurality of decision trees. For example, an input to the gradient boosting model is a 128-dimensional vector including numerical values such as the radio wave intensity (−95 dBm), a customer scale (level 5), and the number of claims (twice). An output from the gradient boosting model is the complexity score (for example, 0.2) and the priority score (for example, 0.85) normalized in a range of 0.0 to 1.0. The project classification unit flags the project as the “simple project” in a case where the output complexity score is less than a preset threshold value (for example, 0.5). The project classification unit flags the project as the “complex project” in a case where the complexity score is equal to or greater than the threshold value. The project classification unit dynamically rearranges a processing order in a project queue based on the calculated priority score. The project classification unit transmits a control signal including a classification result and the priority score to a subsequent construction company selection unit or main person-in-charge assignment unit. Thereby, the system simultaneously evaluates multivariate conditions, quantifies minute risk factors that tend to be overlooked by human intuition, and reflects them in the classification. With this configuration, the system enables optimal allocation of resources and brings about a technical effect of preventing a processing delay of a highly urgent project. The present technology is applicable to an automatic triage system for incidents in a call center and a dynamic prioritization system for delivery routes in a logistics network.
Step 6: Automatic Selection of Construction Company and Ordering Processing for Simple Project In a case where the project is determined to be the simple project, the construction company selection unit automatically selects an optimal construction company by comprehensively evaluating a plurality of parameters such as past records, supported areas, availability statuses, construction periods, costs, quality evaluations, a past trouble history, and evaluations from customers of construction companies using the generative AI. An ordering processing unit automatically generates ordering data for the selected construction company and automatically transmits the ordering data to a system of the construction company. A specific example of a prompt sentence to be read by the generative AI is “Comprehensively evaluate past records, supported areas, availability statuses, construction periods, costs, quality evaluations, trouble histories, and customer evaluations from the following construction company candidates, and select an optimal construction company. Candidates: Construction Company A, Construction Company B, Construction Company C. Project information: 7th floor of Building A, amplifier installation, drawings attached, construction period within 2 weeks, Person in charge B, night construction desired”. Specifically, the construction company selection unit includes an optimization engine based on a reinforcement learning algorithm. The construction company selection unit acquires dynamic parameters (current operation rate, real-time current location, latest quality score, etc.) of each construction company from a database, and constructs a state vector. The construction company selection unit combines requirement data of the project and a feature vector of each construction company, and inputs them into a deep Q-network. The deep Q-network calculates an expected reward value (Q value) in a case where each construction company is selected. For example, an input to the deep Q-network is a multidimensional tensor including a construction period constraint and a cost upper limit of the project, and a past delay rate and a cost overrun rate of each construction company. An output from the deep Q-network is an array of Q values for each construction company candidate (for example, Company A: 85.4, Company B: 62.1, Company C: 91.2). The construction company selection unit determines the construction company (Company C) having the maximum output Q value as an optimal candidate. The ordering processing unit receives an identifier of the determined construction company, and automatically generates structured data (XML or JSON format) for ordering. The ordering processing unit asynchronously transmits the generated ordering data to an external system of the target construction company via a secure API gateway. The ordering processing unit updates a status of the database to “ordered” after the transmission is completed. Thereby, the system realizes dynamic resource optimization that reflects a constantly fluctuating external environment and states of construction companies in real time, rather than static rule-based assignment. With this configuration, the system exhibits a technical effect of shortening a lead time of ordering work to the utmost limit and mathematically optimizing a trade-off between cost and quality. The present technology is applicable to dynamic assignment of drivers in a ride-sharing service and an optimal placement algorithm of virtual machines in cloud computing.
Step 7: Automatic Assignment of Main Person in Charge and Notification for Complex Project In a case where the project is determined to be the complex project, the main person-in-charge assignment unit automatically assigns an optimal main person in charge by comprehensively evaluating expertise, a work load, a past handling history, supportable areas, suitability of technical fields, and the like of the main person in charge using the generative AI, and automatically notifies a terminal of the main person in charge of project contents. A specific example of a prompt sentence to be read by the generative AI is “Comprehensively evaluate expertise, a work load, a past handling history, supportable areas, and suitability of technical fields from the following main person-in-charge candidates, and select an optimal main person in charge. Candidates: Person in charge X, Person in charge Y, Person in charge Z. Project information: 7th floor of Building A, consideration of special amplifier installation, site investigation required, customer attribute=large-scale corporation, night construction desired”. Specifically, the main person-in-charge assignment unit executes a hybrid inference module combining a constraint satisfaction problem solver and a neural network. The main person-in-charge assignment unit acquires a skill matrix, a current task holding amount, and calendar availability of each main person in charge from an internal human resources database. The main person-in-charge assignment unit normalizes these pieces of information and generates a profile vector of each person in charge. The main person-in-charge assignment unit calculates an inner product of a complexity vector of the project and the profile vector of each person in charge, and calculates a technical suitability score. The main person-in-charge assignment unit incorporates the calculated suitability score, a reciprocal of the work load, and a penalty term of a moving distance into an objective function. The main person-in-charge assignment unit searches for a person in charge who maximizes the objective function by a gradient descent method. For example, an input to the inference module is matrix data including a required skill vector of the project (for example, special amplifier knowledge: 0.9, large-scale corporation handling: 0.8) and a possessed skill vector of each person in charge. An output from the inference module is a list of comprehensive evaluation scores for each person in charge, and an identification ID of the person in charge determined to be optimal. The main person-in-charge assignment unit encrypts and transmits project detail data to a mobile terminal of the person in charge via a push notification server based on the output identification ID. The main person-in-charge assignment unit starts an escalation timer to an alternative candidate until an acceptance response is received from the person in charge. Thereby, the system solves assignment work that has relied on personal intuition and experience as a mathematical optimization problem in a multidimensional space. With this configuration, the system exhibits a technical effect of preventing concentration of work on specific human resources and maximizing processing throughput of the entire organization. The present technology is suitably applied to an on-call assignment system for medical specialists in a large-scale hospital and a dispatch system for advanced engineers in IT infrastructure maintenance.
Step 8: Progress Management, Notification, and Feedback Collection A progress management unit monitors a progress status of the project in real time, automatically collects progress reports from the construction company and the main person in charge, and visualizes the progress status. A notification/feedback unit automatically generates notifications and feedback necessary at each processing stage of the project, and transmits them to related parties such as the customer, the sales representative, the construction company, and the main person in charge. For example, it automatically generates various notifications such as a “project reception completion notification”, a “return notification due to information deficiency”, an “order notification to construction company”, a “construction completion notification”, and a “customer questionnaire request”, and also collects feedback and questionnaire results from the customer. Specifically, the progress management unit includes an event tracking engine based on a state machine architecture. The progress management unit asynchronously receives a Webhook event transmitted from an external system or a mobile terminal. The progress management unit extracts a time stamp, position information, and a status code from the received event data, and updates a project record in the database. The progress management unit generates JSON data for drawing a Gantt chart or a Kanban board based on the updated status, and provides the JSON data to a user interface unit. The notification/feedback unit is activated triggered by a status update event, and determines a notification template to be transmitted using a rule engine. The notification/feedback unit embeds dynamic data of the project into the determined template, and generates a personalized message text using a natural language generation model. For example, an input to the natural language generation model is a context vector including a customer name, a completed process name, and a scheduled date and time of a next process. An output from the natural language generation model is a text character string having an appropriate tone and manner tailored to the customer attribute. The notification/feedback unit transmits the generated text as an SMS, an e-mail, or a push notification of a dedicated application. The notification/feedback unit collects an access log for a URL of the transmitted questionnaire and input answer data, and inputs them into an emotion analysis model to quantify a customer satisfaction score. Thereby, the system eliminates information asymmetry among a plurality of stakeholders, and ensures transparency of the project by computer control. With this configuration, the system brings about a technical effect of reducing useless communication traffic and man-hours for telephone handling for progress confirmation, and improving operational efficiency of the entire system. The present technology is applicable to a tracking system for a complex supply chain and an issue tracking system for large-scale software development.
Step 9: History Management and Continuous Learning of AI Model A history management/learning unit automatically records and accumulates a processing history, a determination basis, a construction company selection reason, a main person-in-charge assignment reason, a progress status, feedback from the customer, a construction completion report, a trouble occurrence history, and the like for each project, and utilizes them for future re-learning of the AI model, business improvement, and audit response. For example, trend analysis such as “all projects on the same floor of the same building in the past year were solved by amplifier installation”, “the construction period delay rate of Construction Company A is on a downward trend”, and “customer satisfaction is high in projects handled by Main Person in Charge C” is also possible, and accuracy and efficiency of project processing are continuously improved by utilizing an automatic learning function by AI. Specifically, the history management/learning unit adopts a data lake architecture, and accumulates structured data and unstructured data in an unprocessed state. The history management/learning unit periodically executes ETL (Extract, Transform, Load) processing on the accumulated data, and updates a feature store for machine learning. The history management/learning unit implements an automated machine learning (AutoML) pipeline, and automatically triggers a re-learning process of the model every time a certain amount of new data is accumulated. In the re-learning process, the history management/learning unit defines a difference between a past inference result and an actual outcome (for example, a construction period compliance rate and a customer satisfaction score) as a loss function. The history management/learning unit finely adjusts a weight parameter of a neural network using an error backpropagation method. For example, an input to the re-learning pipeline is pair data of past 10,000 project feature vectors and corresponding correct labels (success/failure, number of delay days, etc.). An output from the re-learning pipeline is a weight file (for example, HDF5 format) of the updated model and accuracy evaluation metrics (precision, recall, F1 score, etc.) for a verification data set. In a case where the accuracy of the new model exceeds that of the existing model, the history management/learning unit seamlessly updates an inference endpoint in a production environment through shadow deployment. Thereby, the system autonomously learns environmental changes and new trends (for example, performance improvement of a specific construction company) and adapts inference logic without intervention of a human data scientist. With this configuration, the system exhibits a technical effect of preventing a concept drift phenomenon in which prediction accuracy of the system deteriorates over time, and ensuring long-term operational stability. The present technology is widely applicable to an algorithmic trading system in a financial market and continuous update of an anomaly detection system in cybersecurity.

### Specific Use Case

For example, a case is assumed where a sales representative of a corporate customer receives a request that radio waves of a business wireless terminal are weak on a plurality of floors of an office building located in an urban area, and inputs project information from an input screen of a terminal. At this time, the sales representative inputs detailed information such as a building name, a building address, an office building as a building type, 3rd and 7th floors as target floor numbers, an area of each floor, the number of surrounding base stations and a base station model, a site photograph, building drawings (PDF file), person-in-charge information, a request source department, a large-scale corporation as a customer attribute, a radio wave intensity measurement value at the site, a desired handling time, presence or absence of a past countermeasure history, a fact that there are many shielding objects on an underground floor as a special circumstance of the site, and a desire for night construction as a request from the customer, and transmits the detailed information to a server via the project information acquisition unit. Specifically, a processor of the terminal buffers the input text data, numerical data, and binary files (JPEG data of the site photograph and PDF data of the building drawings) on a memory. The terminal encodes these heterogeneous data into a multipart form data format, establishes a secure TLS communication channel, and transmits the data to the project information acquisition unit of the server. The project information acquisition unit parses the received data stream and extracts each data field. The project information acquisition unit converts numerical data such as the extracted radio wave intensity measurement value (for example, −95 dBm) and the floor area into a floating-point array. The project information acquisition unit inputs text data (for example, “many shielding objects on underground floor” and “night construction desired”) into a natural language processing model, and generates a word embedding vector. The project information acquisition unit extracts text and vector graphics from the PDF file, and inputs them into an image processing pipeline together with an image file. For example, an input to the image processing pipeline is a plurality of image tensors subjected to resolution downscaling and pixel value normalization. An output from the image processing pipeline is a high-dimensional feature vector expressing structural features (wall material, pillar arrangement, etc.) in the image. The project information acquisition unit combines the numerical array, the word embedding vector, and the image feature vector, and generates a single integrated project vector expressing the project. The project information acquisition unit passes the generated integrated project vector to a subsequent processing module. Thereby, the system converts human sensory report contents into a quantitative multidimensional data structure computable by a computer. With this configuration, the system exhibits a technical effect of equalizing quality of input data in subsequent AI inference and suppressing variation in inference accuracy. The present technology is applicable to a system for automatically processing a complex failure report from a field engineer and a multimodal data collection system in insurance damage assessment.

A project database management unit classifies the received information by building, by floor, by customer, and by progress status, and stores all data including drawings and site photographs in a database. Based on the input project information, the generative AI analysis unit detects omission and inconsistency of text information using a natural language processing model, and analyzes presence or absence of shielding objects and availability of an installation space from the drawings and the site photographs using an image recognition model. For example, in a case where drawing data is not attached, in a case where a site photograph is unclear, or in a case where person-in-charge information is not input, a return notification is automatically transmitted to an applicant as information deficiency. Specifically, the project database management unit distributively stores the received integrated project vector in a composite cluster of a key-value store and a relational database, enabling high-speed query execution. The generative AI analysis unit reads a text vector and an image tensor from the stored data, and simultaneously executes a plurality of inference models on a parallel processing architecture. The image recognition model of the generative AI analysis unit extracts a feature map of edges and textures from a pixel array of the site photograph using a deep layer of a convolutional neural network. Based on the extracted feature map, the image recognition model segments an existence probability of a shielding object (for example, a concrete wall or a metal rack) and an area of a blank space where equipment can be installed in units of pixels. For example, an input to the image recognition model is a normalized RGB image tensor. An output from the image recognition model is a heat map matrix indicating a probability that each pixel belongs to a shielding object or an installation space, and a Laplacian variance score indicating clarity of the image. The generative AI analysis unit determines the image to be “unclear” in a case where the output Laplacian variance score is below a threshold value. At the same time, the natural language processing model of the generative AI analysis unit executes a sequence labeling task using the text vector as an input, and outputs an existence probability of an essential entity (person-in-charge name, contact information, etc.). The generative AI analysis unit integrally evaluates output results of image analysis and text analysis by a logical product operation. In a case where any essential requirement is not satisfied, the generative AI analysis unit generates a JSON payload including an error code and details of a missing item, and immediately transmits it to a terminal of the applicant via the notification/feedback unit. Thereby, the system automates close examination of drawings and quality check of photographs, which have relied on human visual confirmation, by mathematical operations at a pixel level. With this configuration, the system physically blocks incomplete data from being mixed into a subsequent processing process, and brings about a technical effect of dramatically reducing an error rate of the entire system. The present technology is suitably applied to image examination in an online identity verification (eKYC) system and an automatic preliminary check system for building confirmation application.

In a case where the project information is sufficiently prepared, the generative AI analysis unit searches for past similar projects from the database using the building name, the floor, the number of surrounding base stations, the past countermeasure history, the radio wave countermeasure status of surrounding buildings, the radio wave intensity, the floor height, the customer attribute, the request source department, the special circumstances of the site, the customer requests, and the like as inputs, and performs pattern recognition and statistical inference. For example, in a case where there are many solution cases by amplifier installation on other floors of the same building, and the number of surrounding base stations and the customer attribute are also similar, the AI infers that the present project can also be solved by amplifier installation. As a specific example of a prompt sentence to be read by the generative AI, “Search for past similar projects based on the following project information, and infer an optimal radio wave countermeasure method. Project information: building name=office building, floor=3rd and 7th floors, number of surrounding base stations=2, site photograph attached, drawing file attached, customer attribute=large-scale corporation, radio wave intensity at site=−92 dBm, special circumstances=underground floor/many shielding objects, request=night construction desired”. Specifically, upon receiving a flag indicating that the project information is complete, the generative AI analysis unit activates an inference pipeline. The generative AI analysis unit normalizes the input diverse project parameters, and generates a query vector in a high-dimensional feature space. The generative AI analysis unit extracts top K similar projects having a minimum Euclidean distance from the query vector in units of milliseconds from a vector database storing millions of past project vectors using an approximate nearest neighbor search algorithm (for example, HNSW). The generative AI analysis unit aggregates metadata (adopted countermeasure method, radio wave intensity improvement value after construction, etc.) of the extracted similar projects, and inputs them into a transformer-based inference model. The inference model performs weighting calculation of a non-linear correlation between current project parameters (for example, “radio wave intensity=−92 dBm” and “many shielding objects”) and past success cases using a self-attention mechanism. For example, an input to the inference model is tensor data obtained by concatenating a current project vector and top K past project vectors. An output from the inference model is a probability distribution vector that has passed through a softmax function for a plurality of countermeasure classes (amplifier installation, antenna addition, new base station, etc.). In a case where it is determined that a probability of “amplifier installation” is highest (for example, 0.92) in the output probability distribution vector, the generative AI analysis unit determines the countermeasure as an optimal solution. The generative AI analysis unit passes an ID list of past projects that served as a basis for inference and values of attention weights to an explainable AI (XAI) module, and generates text data of an inference reason. Thereby, the system executes advanced pattern recognition based on geometric distance calculation in a multidimensional space, rather than a simple keyword search. With this configuration, the system exhibits a technical effect of reproducing tacit knowledge of a skilled engineer as a mathematical model and maximizing a success probability of a countermeasure. The present technology is applicable to a troubleshooting support system for complex IT infrastructure and a parameter optimization system for yield improvement in the manufacturing industry.

The project determination unit and the project classification unit classify the project as the simple project solvable by standard amplifier installation based on an inference result of the AI, and set a high priority. The construction company selection unit automatically selects an optimal construction company by comprehensively evaluating past records, supported areas, availability statuses, construction periods, costs, quality evaluations, a past trouble history, evaluations from customers, and the like of construction companies using the AI. For example, a construction company having abundant records in the same building, a short construction period, and high customer evaluation is selected. As a specific example of a prompt sentence to be read by the generative AI, “Comprehensively evaluate past records, supported areas, availability statuses, construction periods, costs, quality evaluations, trouble histories, and customer evaluations from the following construction company candidates, and select an optimal construction company. Candidates: Construction Company A, Construction Company B, Construction Company C. Project information: 3rd and 7th floors of office building, amplifier installation, drawings attached, construction period within 2 weeks, person-in-charge information, night construction desired”. Specifically, the project classification unit receives an identification code of the inferred countermeasure class and the calculated probability score as inputs, and determines a routing path of the project using a decision tree algorithm. In a case where the countermeasure class is “amplifier installation” and the probability score exceeds a threshold value, the project classification unit sets a status flag of the project to “simple project”, and inserts it at the top of a priority queue. The construction company selection unit is activated triggered by the simple project flag, and acquires dynamic profile data of candidate construction companies from the database. The construction company selection unit normalizes the acquired profile data (number of past constructions in the same building, average number of construction period days, average value of customer evaluation scores, etc.), and constructs a feature matrix of each construction company. The construction company selection unit inputs the feature matrix and a requirement vector of the project (night construction flag, construction period constraint, etc.) into a multilayer perceptron-based scoring model. The scoring model calculates a comprehensive suitability score of each construction company by applying a non-linear activation function to a weighted sum of each feature. For example, an input to the scoring model is a combined tensor of a 100-dimensional feature vector for each construction company and a project requirement vector. An output from the scoring model is a suitability score in a range of 0 to 1 for each construction company (for example, Company A: 0.88, Company B: 0.45, Company C: 0.95). The construction company selection unit locks the construction company (Company C) having the maximum output score as an optimal candidate, and updates a resource allocation table on the database. Thereby, the system calculates a plurality of constraint conditions and fluctuating external factors in real time, and completely eliminates manual competitive estimation and schedule adjustment work by a human. With this configuration, the system brings about a technical effect of shortening a lead time for selecting an ordering destination from several days to several milliseconds, and dramatically accelerating progress of the entire project. The present technology is applicable to a task assignment algorithm in an on-demand gig worker platform and an optimal node placement system for containers in a cloud environment.

The ordering processing unit automatically generates ordering data for the selected construction company and automatically transmits the ordering data to a system of the construction company. For example, order contents such as “3rd and 7th floors of office building, amplifier installation, drawings attached, construction period within 2 weeks, night construction desired” are automatically transmitted. A progress management unit automatically collects progress reports from the construction company, records progress for each process such as start of construction, completion of site investigation, completion of amplifier installation, and construction completion report, and automatically issues an alert in a case where a delay occurs. A notification/feedback unit automatically generates various notifications such as a project reception completion notification, an order notification to the construction company, a construction completion notification, and a customer questionnaire request, and also collects feedback and questionnaire results from the customer. Specifically, the ordering processing unit extracts detailed data of the project and binary data of an attached file from a database based on an identification ID of the selected construction company. The ordering processing unit serializes the extracted data into a structured JSON payload, and transmits the structured JSON payload as an HTTP POST request to an external system of the construction company via a RESTful API. The ordering processing unit implements an automatic retry mechanism using an exponential backoff algorithm in preparation for a network error during transmission. The progress management unit provides a dedicated endpoint for receiving a Webhook of a status update transmitted from the system of the construction company. The progress management unit extracts a process code and a timestamp from the received Webhook payload, and updates a progress tracking table in the database. The progress management unit periodically executes a background worker that compares a scheduled completion date and time of each process with an actual timestamp. An input to the progress management unit is a current timestamp and scheduled schedule data of each project. An output from the progress management unit is an ID list of projects exceeding the scheduled date and time and a calculated value of a delay time. In a case where a delay is detected, the progress management unit fires an alert event and transmits the alert event to the notification/feedback unit. Upon receiving the alert event, the notification/feedback unit generates a message text for escalation using a natural language generation model, and transmits a push notification to an administrator dashboard and mobile terminals of related parties. When receiving a construction completion event, the notification/feedback unit automatically generates a message including a URL of a questionnaire form, and transmits the message to the customer to collect evaluation data. Thereby, the system completely automates data linkage between systems, and monitors a progress status of the project in real time and accurately. With this configuration, the system exhibits a technical effect of preventing an artificial reporting omission and a confirmation delay, and accelerating an initial response at the time of trouble occurrence to the utmost limit. The present technology is suitably applied to a management system for a large-scale construction project involving a plurality of subcontractors, and a global logistics tracking system.

Further, in a case where the project is determined to be the complex project, a main person in charge assignment unit comprehensively evaluates expertise, a work load, a past handling history, supported areas, suitability of technical fields, and the like of the main person in charge using the AI, automatically assigns an optimal main person in charge, and automatically notifies project contents to a terminal of the main person in charge. As a specific example of a prompt sentence to be read by the generative AI, “Comprehensively evaluate expertise, a work load, a past handling history, supported areas, and suitability of technical fields from among the following candidates for the main person in charge, and select an optimal main person in charge. Candidates: person in charge X, person in charge Y, person in charge Z. Project information: 3rd and 7th floors of office building, consideration of special amplifier installation, site investigation required, customer attribute=large-scale corporation, night construction desired” is used. Specifically, the main person in charge assignment unit that has received a complex project flag from the project classification unit activates an inference engine that executes an advanced matching algorithm. The main person in charge assignment unit acquires skill set vectors of all engineers, a length of a current task queue, and GPS-based current position coordinates in real time from a human resources database. The main person in charge assignment unit encodes required specifications of the project (knowledge of special amplifiers, skills for handling large-scale corporations, etc.) into a multidimensional requirement vector. The main person in charge assignment unit calculates a cosine similarity between the requirement vector and the skill set vector of each engineer, and quantifies a technical suitability. Furthermore, the main person in charge assignment unit calculates a load penalty score based on the length of the task queue of each engineer, and a distance penalty score based on a travel time from the current position to the site. For example, an input to the inference engine is a feature matrix including the requirement vector, the skill vector of each engineer, the load score, and the distance score. An output from the inference engine is a calculated value of a comprehensive evaluation function for each engineer (for example, person in charge X: 0.75, person in charge Y: 0.92, person in charge Z: 0.60). The main person in charge assignment unit selects the person in charge (person in charge Y) having the maximum output calculated value as an optimal candidate, and updates a person in charge ID field in the database. The main person in charge assignment unit transmits a push notification including detailed data of the project and optimal route information to the site to the mobile terminal of the selected person in charge via an encrypted communication channel. Thereby, the system instantaneously solves a multi-objective optimization problem of simultaneously optimizing skills, loads, and geographical conditions for a task requiring high expertise on a computer. With this configuration, the system exhibits a technical effect of avoiding concentration of work on a specific expert and maximizing a resource utilization rate of the entire organization. The present technology is applicable to a dynamic dispatch system for field service engineers distributed over a wide area, and an automatic assignment system for maintenance support requiring an emergency response.

A history management/learning unit automatically records and accumulates a processing history, a determination basis, a construction company selection reason, a main person in charge assignment reason, a progress status, feedback from a customer, a construction completion report, a trouble occurrence history, and the like for each project, and utilizes them for future re-learning of the AI model, business improvement, and audit response. For example, trend analysis such as “all projects on the same floor of the same building in the past year were solved by amplifier installation”, “a construction period delay rate of construction company A is on a downward trend”, and “customer satisfaction is high in projects handled by main person in charge C” is also possible, and accuracy and efficiency of project processing are continuously improved by utilizing an automatic learning function by the AI. Specifically, the history management/learning unit includes a data warehouse constructed on a distributed file system, and persists all transaction logs and inference logs generated in the system as time-series data. The history management/learning unit applies natural language processing and statistical feature extraction to the accumulated log data, and automatically generates a learning data set for the machine learning model. The history management/learning unit executes a fine-tuning process of a deep learning model in the background using the generated data set by a periodic cron job. In the fine-tuning process, the history management/learning unit calculates a mean square error between a past inference result (for example, selection of a construction company) and an actual performance index (for example, an actual construction period or a customer evaluation score) as a loss function. The history management/learning unit iteratively updates weight parameters of a neural network using an Adam optimizer. For example, an input to the learning process is tensor data including a past project feature vector and an actual success/failure label or a continuous value of the number of delay days corresponding thereto. An output from the learning process is an optimized new weight matrix and transition graph data of a loss value for a verification data set. After confirming that the loss value of the new model is lower than that of the existing model, the history management/learning unit updates a model file on an inference server without stopping by hot swapping. The history management/learning unit executes principal component analysis or k-means clustering on the accumulated data, extracts hidden patterns such as a performance transition of a construction company and a seasonal trend of radio wave interference in a specific building, and visualizes the hidden patterns on a dashboard. Thereby, the system forms an autonomous feedback loop that refines its own inference logic as the operation continues. With this configuration, the system brings about a technical effect of adapting to changes in an external environment and new failure patterns without human intervention, and maintaining and improving long-term prediction accuracy. The present technology is widely applicable to a continuous integration system for a demand prediction model and an automatic update system for an anomaly detection model in a manufacturing line.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

In an embodiment of the present invention, an automatic processing system for urban infrastructure failure countermeasures targets a wide variety of IoT devices and communication equipment installed in a city, that is, streetlights, traffic signals, surveillance cameras, environmental sensors, public Wi-Fi access points, smart parking meters, smart trash cans, meteorological observation devices, disaster warning terminals, digital signage, electric bus stop terminals, smart water meters, smart power meters, and the like, and centrally receives failure reports and automatic detection information from residents, field workers, city administrators, remote monitoring systems, periodic inspection systems, and the like regarding all failures, abnormalities, and performance deteriorations occurring in these devices, such as communication disconnection, power disconnection, equipment failure, performance deterioration, data loss, abnormal operation, malfunction, video interruption, sensor value abnormality, firmware failure, remote operation impossibility, abnormal heat generation, abnormal sound generation, external damage, installation position deviation, battery abnormality, network delay, restart impossibility, and software crash. Specifically, the system adopts a distributed computing architecture. The system acquires time-series operation log data transmitted from each IoT device as a multidimensional tensor. The system preprocesses the acquired multidimensional tensor. The system inputs the preprocessed data into an anomaly detection model. The system uses an autoencoder-type neural network as the anomaly detection model. The system calculates an error between the input data and reconstructed data. The system determines an abnormality in a case where the calculated error exceeds a predetermined threshold. The system receives, as input data, a one-dimensional numerical array indicating, for example, temperature, humidity, voltage, and communication delay time for the past 24 hours. The system generates, as an output, a floating-point number in a range of 0 to 1 indicating an abnormality probability of each device. For example, the output is a numerical value of an abnormality probability of 0.92. The system transmits this output result to a subsequent failure report information acquisition unit. The system trains the model using a cross-entropy error function. The system updates weight parameters by a gradient descent method. Thereby, the system detects minute performance deterioration in real time, which is impossible by human visual monitoring. The system exhibits a technical effect of minimizing downtime of urban infrastructure. The system is applicable to a wide-area infrastructure monitoring field in a smart city.

The failure report information acquisition unit includes various input channels such as a smartphone application, a web portal, an administrator terminal, a field worker tablet, a remote monitoring system API, and a periodic inspection robot, enables a reporter to input an equipment type, an installation location (address, latitude and longitude, landmark, floor information, installation height, etc.), failure contents (selective/free description type), a site photograph and a video (JPEG, PNG, MP4, etc.), reporter information (name, contact information, affiliation, authority level, etc.), an occurrence date and time, a detailed failure explanation (e.g., occurring only at night, occurring only in rainy weather, occurring periodically, occurring suddenly, occurring simultaneously in multiple devices, etc.), site environmental information (e.g., presence or absence of surrounding construction, traffic volume, weather conditions, surrounding radio wave environment, etc.), presence or absence of a past failure history, special circumstances of the site (e.g., underground installation, rooftop installation, outdoor installation, dense area installation, hazardous area installation, etc.), and requests (e.g., urgent response desired, night work desired, simultaneous response to multiple devices desired, site presence desired, etc.), and transmits these pieces of information to a server in real time. For example, a resident can discover a failure such as “a smart trash can in 3-chome, Ward B is disconnected from communication and remaining amount information cannot be acquired”, “a surveillance camera in 1-chome, Ward C repeatedly interrupts video”, “a smart parking meter in 5-chome, Ward D malfunctions and a billing error occurs”, “digital signage in 2-chome, Ward E causes a display abnormality”, or “a disaster warning terminal in 4-chome, Ward F emits an abnormal sound”, attach a site photograph or a video, describe a detailed situation explanation or a request, and report the failure. Specifically, the failure report information acquisition unit converts received text data and image data into structured data. The failure report information acquisition unit inputs the text data into a natural language processing model. The natural language processing model adopts a transformer architecture. The natural language processing model converts the input text into a word embedding vector. The natural language processing model analyzes a context using a self-attention mechanism. The failure report information acquisition unit inputs the image data into a convolutional neural network. The convolutional neural network extracts a feature map from an image tensor. The failure report information acquisition unit receives, as input data, for example, a 224-pixel square RGB image tensor or a 512-dimensional text embedding vector. The failure report information acquisition unit generates, as an output, numerical data indicating an urgency score of the failure or a damage probability of the equipment. For example, the output is numerical values of an urgency score of 85 and a damage probability of 0.78. The failure report information acquisition unit integrates these output scores. The failure report information acquisition unit transmits the integrated score to a subsequent project database management unit. The failure report information acquisition unit augments learning data using a data augmentation method. Thereby, the system realizes objective and quantitative evaluation of report contents. The system exhibits a technical effect of enabling highly accurate initial triage independent of human subjectivity. The system is applicable to a citizen reporting system of a local government, and the like.

A project database management unit classifies and tags the received failure report information in multiple dimensions such as an equipment type, an installation location, failure contents, a report date and time, a progress status, a reporter attribute, site environmental conditions, a failure occurrence frequency, a past failure history, handling records of work companies and technicians, a site photograph and a video file, drawing data, a site environmental sensor value, meteorological data, and traffic volume data, and stores the failure report information in a database. For example, a failure history occurred in the past with the same equipment type and the same installation location, an occurrence frequency of the same failure contents, multiple reports by the same reporter, simultaneous failures of multiple devices at the same site, a failure occurrence trend for each season, a correlation with weather conditions, a relevance to surrounding construction, a past handling history, handling records of work companies and technicians, a customer satisfaction evaluation, a work completion report, a trouble occurrence history, and the like are also linked and managed, and utilized for failure trend analysis, preventive maintenance plan formulation, and re-learning of the AI model. Specifically, the project database management unit stores information using a graph database. The project database management unit defines each failure report as a node. The project database management unit defines the equipment type and the installation location as edges. The project database management unit calculates a similarity between nodes by cosine similarity calculation. The project database management unit executes clustering processing based on the calculated similarity. The project database management unit forms clusters using a K-means algorithm. The project database management unit receives, as input data, a multidimensional numerical vector indicating features of each failure report. For example, the input data is a 128-dimensional vector including an equipment type ID, latitude and longitude, and a timestamp of an occurrence date and time. The project database management unit generates, as an output, a list of cluster IDs to which each node belongs. For example, the output is an integer value of a cluster ID of 5. The project database management unit provides this cluster ID to inference processing of a subsequent failure determination unit. The project database management unit extracts a failure occurrence trend pattern from the formed clusters. Thereby, the system realizes high-speed similar event retrieval from a huge amount of history data. The system exhibits a technical effect of significantly reducing a calculation amount of data retrieval. The system is applicable to a large-scale equipment maintenance management system.

The failure determination unit analyzes the failure report information using generative AI. The generative AI detects omissions and inconsistencies in text information using a natural language processing model, automatically extracts a state of equipment and an abnormal part (e.g., damage, corrosion, disconnection, liquid crystal crack, display abnormality, installation deviation, foreign matter mixing, external damage, etc.) from a site photograph or a video using an image recognition model, and extracts an abnormal pattern or an abnormal time series from a sensor value or log data using an anomaly detection model. For example, in a case such as “installation location is not entered”, “failure contents are ambiguous”, “site photograph is unclear”, “reporter information is not entered”, “site environmental information is insufficient”, “failure occurrence date and time is unknown”, or “relevance of simultaneous failures of multiple devices is unknown”, a return notification is automatically transmitted to the reporter as information deficiency. In a case where the information is complete, the generative AI searches a database for past similar failure cases using a plurality of elements such as the equipment type, the installation location, the failure contents, the site photograph, the video, a past failure history, a failure occurrence frequency, site environmental conditions, a reporter attribute, the occurrence date and time, a detailed failure explanation, a site environmental sensor value, meteorological data, traffic volume data, surrounding construction information, a past handling history, handling records of work companies and technicians, a customer satisfaction evaluation, a work completion report, and a trouble occurrence history as inputs, and performs pattern recognition, statistical inference, anomaly detection, time-series analysis, clustering, causal inference, and risk evaluation. For example, by referring to a history such as “a communication disconnection occurred in a smart trash can in 3-chome, Ward B in the past, and was recovered by a restart”, “a video interruption occurred in a surveillance camera in 1-chome, Ward C, and was solved by equipment replacement”, “a billing error occurred in a smart parking meter in 5-chome, Ward D, and was improved by a firmware update”, “a display abnormality occurred in digital signage in 2-chome, Ward E, and was recovered by display module replacement”, or “an abnormal sound occurred in a disaster warning terminal in 4-chome, Ward F, and external damage was found by a site investigation”, the generative AI classifies with high accuracy whether the failure is a simple failure solvable by a past solution or a complex failure requiring a site investigation or advanced handling. Furthermore, the AI also performs trend analysis of failure occurrence, identification of equipment or a location with a high failure occurrence frequency, automatic extraction of an abnormal pattern, sign detection of abnormality occurrence, prediction of a failure occurrence risk, evaluation of a failure ripple risk, priority determination at the time of failure occurrence, optimal resource allocation for failure handling, and the like. Specifically, the failure determination unit executes an ensemble model integrating a plurality of specialized neural networks. The failure determination unit acquires an image tensor, a text embedding vector, and a time-series array of sensor values as input data. For example, the image tensor is 224-pixel square 3-channel RGB image data. The text embedding vector is a 768-dimensional numerical vector. The time-series array of sensor values is a one-dimensional array indicating temperature and voltage for the past 24 hours. The failure determination unit combines these pieces of input data in a combining layer. The failure determination unit inputs the combined data into a fully connected layer. The failure determination unit generates a softmax distribution of a simple failure probability and a complex failure probability as an output. For example, the output is numerical values of a simple failure probability of 0.85 and a complex failure probability of 0.15. The failure determination unit compares this output probability with a predetermined threshold. The failure determination unit sets a simple failure flag in a case where the simple failure probability exceeds the threshold. The failure determination unit transmits this flag to a subsequent failure handling processing unit. The failure determination unit is trained using a cross-entropy error function. The failure determination unit updates weight parameters by a gradient descent method. Thereby, the system realizes highly accurate automatic classification based on multimodal data. The system exhibits a technical effect of enabling objective failure determination independent of human rules of thumb. The system is applicable to network failure isolation work of a communication carrier, and the like.

Based on a determination result of the failure determination unit, the failure handling processing unit automatically executes selection of a work company or a field technician and ordering processing using generative AI in a case of the simple failure. The AI comprehensively evaluates a plurality of parameters such as past records (e.g., number of handled cases for the same equipment type and the same installation location, handling speed, handling quality, customer satisfaction evaluation, trouble occurrence rate, construction period compliance rate, cost record, etc.), supported areas (e.g., citywide support, specific ward support, remote area support, etc.), availability statuses (e.g., same-day support available, next-day support available, weekend support available, night support available, etc.), construction periods (e.g., standard construction period, short delivery time support, long-term support, etc.), costs (e.g., standard price, premium charge, discount support, etc.), quality evaluations (e.g., customer questionnaire, site audit, third-party evaluation, etc.), a past trouble history (e.g., construction period delay, work mistake, reporting delay, site trouble, etc.), and evaluations from reporters (e.g., polite handling, prompt reporting, easy-to-understand site explanation, etc.) of work companies and technicians, and automatically selects an optimal work company or technician. For example, the AI selects based on information such as “operator_A has a record of handling a smart trash can in 3-chome, Ward B multiple times in the past and is currently available”, “operator_B has a short construction period for a similar failure”, and “operator_C has a low cost but a low quality evaluation”, automatically generates ordering data, and automatically transmits the ordering data to the work company. Order contents include specific instructions such as “smart trash can in 3-chome, Ward B, communication disconnection, restart handling, site photograph attached, urgent response desired”. The work company or the technician performs site handling based on the received instructions, and inputs a progress status and a work completion report to the system. Specifically, the failure handling processing unit selects an optimal work company using a reinforcement learning algorithm. The failure handling processing unit models each work company as an agent. The failure handling processing unit defines past records and availability statuses of the work company as a state vector. The failure handling processing unit defines ordering processing as an action. The failure handling processing unit sets construction period compliance and cost reduction as a reward function. The failure handling processing unit updates an action value function using a Q-learning algorithm. The failure handling processing unit uses an evaluation score array of each work company and coordinate data of a supportable area as input data. For example, the evaluation score array is a three-dimensional vector indicating quality, speed, and cost. The failure handling processing unit generates a selection probability distribution of each work company as an output. For example, the output is probability values of 0.7 for work company A, 0.2 for work company B, and 0.1 for work company C. The failure handling processing unit selects a work company with the highest probability. The failure handling processing unit calls an ordering API based on this selection result. Thereby, the system realizes optimal resource allocation adapted to dynamically changing site situations. The system exhibits a technical effect of dramatically shortening calculation processing time of ordering work. The system is applicable to an automatic dispatch system for field engineers.

In a case of the complex failure, the failure handling processing unit comprehensively evaluates expertise (e.g., surveillance camera failure analysis, smart parking meter failure analysis, IoT communication failure analysis, firmware failure analysis, network failure analysis, power supply failure analysis, sensor abnormality analysis, site environmental abnormality analysis, etc.), a work load (e.g., number of currently handled projects, overtime hours, supportable time zone, etc.), a past handling history (e.g., handling record for the same equipment type and the same failure contents, site investigation experience, failure analysis experience, etc.), supportable areas (e.g., citywide support, specific ward support, remote area support, etc.), suitability of technical fields (e.g., indoor equipment specialty, outdoor equipment specialty, communication equipment specialty, power supply equipment specialty, etc.), and the like of an expert technician using the AI, and automatically assigns an optimal expert technician. For example, the failure handling processing unit selects based on information such as “technician X is familiar with failure analysis of surveillance cameras and has handled many similar complex failures in the past”, “technician Y has a high current work load and is excluded from assignment”, and “technician Z has abundant experience in handling failures of outdoor equipment”, and automatically notifies the failure contents to a terminal of the technician. The technician implements advanced handling such as a site investigation, detailed failure analysis, equipment replacement, redesign of the entire system, firmware analysis, network reconstruction, sensor recalibration, site environmental improvement, and consideration of failure ripple prevention measures, and inputs a progress status and a work completion report to the system. Specifically, the failure handling processing unit performs matching of expert technicians using a graph neural network. The failure handling processing unit expresses a skill set of the technician and required skills of the failure as multidimensional vectors, respectively. The failure handling processing unit maps these vectors to a high-dimensional feature space. The failure handling processing unit calculates a Euclidean distance between the vectors in the feature space. The failure handling processing unit specifies a technician having the minimum calculated distance. The failure handling processing unit uses text data indicating a past handling history of the technician and categorical data of qualification information as input data. For example, the input data is an array of possessed qualification IDs of the technician or an integer value of the number of past handled projects. The failure handling processing unit generates a list of suitability scores of each technician as an output. For example, the output is numerical data of a score of 95 for technician X and a score of 40 for technician Y. The failure handling processing unit sorts this score list in descending order. The failure handling processing unit automatically transmits a notification packet to the top technician. Thereby, the system instantaneously executes optimal technician assignment satisfying complex constraint conditions. The system exhibits a technical effect of improving assignment accuracy of a task requiring high expertise. The system is applicable to advanced maintenance support work of IT infrastructure.

A progress management unit automatically collects progress reports (site arrival, work start, restart completion, equipment replacement completion, recovery confirmation, site investigation completion, failure analysis completion, firmware update completion, network reconstruction completion, sensor recalibration completion, site environmental improvement completion, failure ripple prevention measure implementation completion, etc.) from work companies and technicians, and notifies an administrator and a reporter in real time. For example, progress information such as “work company arrived at site”, “restart work implemented”, “equipment replacement completed”, “failure recovered”, “site investigation completed”, “failure analysis completed”, “firmware update completed”, “network reconstruction completed”, “sensor recalibration completed”, “site environmental improvement completed”, and “failure ripple prevention measure implemented” is automatically visualized. In a case where a delay occurs, an alert is automatically issued to prompt the administrator and the reporter to respond promptly. The progress management unit also implements timeline display of a progress status, automatic detection of a progress delay, automatic aggregation of progress reports, dashboard display of a progress status, automatic report generation of a progress status, and the like. Specifically, the progress management unit adopts an event-driven architecture. The progress management unit asynchronously receives a status update packet transmitted from each terminal. The progress management unit analyzes a timestamp of the received packet. The progress management unit calculates a difference between a scheduled work schedule and an actual timestamp. The progress management unit generates a delay flag in a case where this difference exceeds an allowable threshold. The progress management unit activates an alert generation module using the delay flag as a trigger. The progress management unit uses a UNIX timestamp indicating a work start time or a completion time as input data. For example, the input data is an integer value of 1625097600. The progress management unit generates numerical data indicating a progress delay probability or a predicted completion time as an output. For example, the output is data of a delay probability of 0.8 and a predicted completion time of 1625101200. The progress management unit transmits this output data to a drawing engine of a dashboard. Thereby, the system tracks statuses of tens of thousands of simultaneously progressing projects without delay. The system exhibits a technical effect of realizing real-time state synchronization without compressing a network bandwidth. The system is applicable to progress management of a large-scale construction project.

A history management and learning unit automatically records and accumulates a processing history for each failure, a determination basis, a work company selection reason, a technician assignment reason, a progress status, feedback from a reporter, a work completion report, a trouble occurrence history, a customer satisfaction evaluation, site environmental data, meteorological data, traffic volume data, surrounding construction information, a failure occurrence tendency, a failure occurrence sign, a failure ripple risk, failure handling resource allocation, a failure handling cost, failure handling quality, a failure handling speed, failure handling efficiency, failure handling accuracy, a failure handling automation rate, a failure handling standardization rate, a failure handling optimization rate, and the like, and utilizes them for future re-learning of an AI model, business improvement, audit response, failure tendency analysis, preventive maintenance plan formulation, failure occurrence risk evaluation, failure ripple risk evaluation, optimal failure handling resource allocation, failure handling cost reduction, failure handling quality improvement, failure handling speed improvement, failure handling efficiency improvement, failure handling accuracy improvement, failure handling automation rate improvement, failure handling standardization rate improvement, failure handling optimization rate improvement, and the like. For example, tendency analysis such as “all communication disconnection failures of the same streetlight in the past year were solved by restarting”, “a construction period delay rate of operator_A is on a downward trend”, “reporter satisfaction is high in projects handled by technician X”, “communication disconnection failures frequently occur in a smart trash can in 3-chome, Ward B”, “video interruption failures are on an increasing trend in a surveillance camera in 1-chome, Ward C”, “billing error failures are on a decreasing trend in a smart parking meter in 5-chome, Ward D”, “display abnormality failures in digital signage in 2-chome, Ward E correlate with seasonal fluctuations”, and “abnormal sound failures in a disaster warning terminal in 4-chome, Ward F correlate with surrounding construction” is also possible. By utilizing an automatic learning function by AI, accuracy and efficiency of failure handling are continuously improved. Specifically, the history management and learning unit constructs a continuous learning pipeline. The history management and learning unit periodically batch-processes the accumulated processing history data. The history management and learning unit extracts a feature vector from the processing history data. The history management and learning unit fine-tunes the existing AI model using this feature vector. The history management and learning unit fine-tunes weights of the model using a backpropagation method. The history management and learning unit uses text data of the work completion report and a numerical score of the customer satisfaction as input data. For example, the input data is an integer value from 1 to 5 indicating the customer satisfaction, or a numerical value in minutes of work time. The history management and learning unit generates a weight parameter matrix of the updated model as an output. For example, the output is a multidimensional tensor including millions of floating-point numbers. The history management and learning unit deploys this weight parameter matrix to an inference server. The history management and learning unit applies a dropout method to prevent overfitting. Thereby, the system autonomously adapts to environmental changes and new failure patterns. The system exerts a technical effect of improving inference accuracy of the model over time. The system is applicable to a self-evolving system operation management infrastructure.

Furthermore, in the present embodiment, expansion of the AI model, enhancement of the database, customization of a user interface, and cooperation with external systems (an urban management system, a remote monitoring system, a disaster response system, a traffic control system, a meteorological information system, a construction management system, a resident reporting application, and the like) are also possible so as to flexibly respond to various equipment and failure patterns of urban infrastructure. For example, even in a case where a large number of failure reports are concentrated when a disaster occurs, the AI can automatically determine a priority of the failure and preferentially handle important infrastructure. In addition, it is also possible to visualize a failure occurrence tendency of the entire city in real time and propose an optimal timing for preventive maintenance and equipment update to a city operator. Furthermore, failure occurrence sign detection, failure ripple risk evaluation, optimal failure handling resource allocation, failure handling cost reduction, failure handling quality improvement, failure handling speed improvement, failure handling efficiency improvement, failure handling accuracy improvement, failure handling automation rate improvement, failure handling standardization rate improvement, failure handling optimization rate improvement, and the like by the AI can also be realized. Specifically, the system adopts a microservices architecture to loosely couple each function. The system provides a RESTful API endpoint for cooperation with the external systems. The system automatically scales out compute nodes using a container orchestration tool in a case where traffic rapidly increases when a disaster occurs. The system uses precipitation data from the meteorological information system and traffic jam length data from the traffic control system as input data. For example, the precipitation data is a floating-point number indicating millimeters per hour. The system generates heat map data of a failure occurrence prediction probability of each area as an output. For example, the output is two-dimensional array data indicating the prediction probability of each mesh. The system distributes this heat map data to a terminal of an urban administrator. Thereby, the system maintains stable processing performance even against sudden load fluctuations. The system exerts a technical effect of dramatically improving availability and fault tolerance of the entire system. The system is applicable to an integrated operation center of a smart city.

As described above, the automatic processing system for urban infrastructure failure countermeasures of the present invention seamlessly automates processes from failure report reception to information deficiency determination, automatic collation with a past history, failure classification, automatic selection and ordering of a work company and a technician, progress management, history management, AI learning, failure tendency analysis, failure occurrence sign detection, failure ripple risk evaluation, optimal failure handling resource allocation, failure handling cost reduction, failure handling quality improvement, failure handling speed improvement, failure handling efficiency improvement, failure handling accuracy improvement, failure handling automation rate improvement, failure handling standardization rate improvement, and failure handling optimization rate improvement, and realizes operational efficiency improvement of urban infrastructure, speeding up of failure handling, optimal allocation of human resources, reduction of operation costs, service quality improvement for urban residents, resilience enhancement of the entire city, and sophistication and autonomization of urban operation. Specifically, the system includes a workflow engine that completely automates a series of processing flows. The workflow engine executes data transfer between respective processing modules at high speed via a message queue on a memory. The system reduces latency of data processing to a millisecond unit by eliminating human intervention. The system uses all transaction logs from the failure report to the completion report as input data. For example, the input data is structured log data including a start time and an end time of each processing step. The system calculates a KPI score indicating processing efficiency of the entire system as an output. For example, the output is numerical data in milliseconds indicating an average processing time. The system automatically identifies a bottleneck based on this KPI score. Thereby, the system completely eliminates waiting times and transmission errors inherent in conventional manual processes. The system exerts a technical effect of ensuring continuity and completeness of information processing. The system is applicable to a completely unmanned solution for all infrastructure management.

### System Configuration

The system according to the present embodiment includes a failure report information acquisition unit, a project database management unit, a generative AI analysis unit, a failure determination unit, a failure classification unit, a work company selection unit, an ordering processing unit, an expert technician assignment unit, a progress management unit, a history management and learning unit, and a user interface unit.

The failure report information acquisition unit centrally receives failure reports regarding various IoT devices and communication equipment such as streetlights, traffic signals, surveillance cameras, environmental sensors, public Wi-Fi access points, smart parking meters, smart trash cans, meteorological observation devices, disaster warning terminals, digital signage, electric bus stop terminals, smart water meters, and smart power meters in a city from a resident, a field worker, an urban administrator, a remote monitoring system, a periodic inspection system, and the like. For example, various input channels such as a smartphone application, a web portal, an administrator terminal, a field worker tablet, a remote monitoring system API, and a periodic inspection robot are provided, and a reporter can input an equipment type, an installation location (an address, latitude and longitude, a landmark, floor information, an installation height, and the like), failure contents (a selective type/a free description type), a site photograph and a video (JPEG, PNG, MP4, and the like), reporter information (a name, contact information, an affiliation, an authority level, and the like), an occurrence date and time, a detailed failure explanation, site environmental information (presence or absence of surrounding construction, a traffic volume, meteorological conditions, a surrounding radio wave environment, and the like), presence or absence of a past failure history, special circumstances of a site (underground installation, rooftop installation, outdoor installation, dense area installation, hazardous area installation, and the like), and requests (a request for urgent handling, a request for night work, a request for simultaneous handling of a plurality of devices, a request for site presence, and the like), and these pieces of information are transmitted to a server in real time. For example, a resident can discover a failure such as “a smart trash can in 3-chome, Ward B is disconnected from communication and remaining amount information cannot be acquired”, “a surveillance camera in 1-chome, Ward C repeatedly interrupts video”, “a smart parking meter in 5-chome, Ward D malfunctions and a billing error occurs”, “digital signage in 2-chome, Ward E causes a display abnormality”, and “a disaster warning terminal in 4-chome, Ward F emits an abnormal sound”, attach a site photograph and a video, describe a detailed situation explanation and requests, and report the failure. Specifically, the failure report information acquisition unit utilizes edge computing technology. The failure report information acquisition unit executes initial data filtering on an edge device arranged in each input channel. The failure report information acquisition unit receives GPS coordinate data and time-series data of a gyro sensor transmitted from a smartphone as input data. For example, the GPS coordinate data is a pair of floating-point numbers indicating latitude and longitude. The failure report information acquisition unit generates a normalized data stream from which noise is removed as an output. For example, the output is a smoothed numerical array from which abnormal values are removed. The failure report information acquisition unit encrypts and transmits this normalized data stream to a central server. Thereby, the system significantly reduces consumption of a communication bandwidth of the central server. The system exerts a technical effect of eliminating a processing bottleneck for a large number of simultaneous reports. The system is applicable to a data collection infrastructure of a sensor network distributed over a wide area.

The project database management unit classifies and tags the received failure report information in multiple dimensions such as an equipment type, an installation location, failure contents, a report date and time, a progress status, a reporter attribute, site environmental conditions, a failure occurrence frequency, a past failure history, handling records of work companies and technicians, a site photograph and a video file, drawing data, a site environmental sensor value, meteorological data, and traffic volume data, and stores them in a database. For example, a failure history occurred in the past with the same equipment type and the same installation location, an occurrence frequency of the same failure contents, a plurality of reports by the same reporter, simultaneous failures of a plurality of devices at the same site, a failure occurrence tendency for each season, a correlation with meteorological conditions, a relevance to surrounding construction, a past handling history, handling records of work companies and technicians, a customer satisfaction evaluation, a work completion report, a trouble occurrence history, and the like are also linked and managed, and utilized for failure tendency analysis, preventive maintenance plan formulation, and re-learning of the AI model. Specifically, the project database management unit configures a distributed relational database and a NoSQL database in a hybrid manner. The project database management unit stores structured data in the relational database. The project database management unit stores images and videos, which are unstructured data, in an object storage. The project database management unit receives an array of multidimensional metadata tags as input data. For example, the input data is data in a JSON format including an equipment ID, a failure code, and a priority flag. The project database management unit generates a unique hash index for each data record as an output. For example, the output is a 256-bit hexadecimal character string. The project database management unit realizes high-speed pointer reference using this hash index. Thereby, the system maintains a search response speed on the order of milliseconds even for petabyte-class large-scale data. The system exerts a technical effect of optimizing IOPS performance of data storage. The system is applicable to an integrated data lake premised on big data analysis.

The generative AI analysis unit performs analysis by combining a plurality of AI technologies such as a natural language processing model, an image recognition model, an anomaly detection model, a time-series analysis model, a clustering model, a causal inference model, and a risk evaluation model, using various data such as failure report information, a past failure history, a site photograph, a video, site environmental data, meteorological data, traffic volume data, surrounding construction information, handling records of work companies and technicians, a customer satisfaction evaluation, a work completion report, and a trouble occurrence history as inputs. For example, an equipment state and an abnormal part (breakage, corrosion, disconnection, liquid crystal crack, display abnormality, installation deviation, foreign matter mixing, external damage, and the like) are automatically extracted from the site photograph and the video, an abnormal pattern and an abnormal time series are extracted from a sensor value and log data, omission and inconsistency of text information are detected, and failure occurrence tendency analysis, abnormality occurrence sign detection, failure ripple risk evaluation, optimal failure handling resource allocation, and the like are also performed. As a specific example of a prompt sentence to be read by the generative AI, “Based on the following failure report information and site photograph, search for past similar failure cases and infer an optimal countermeasure method. Failure report information: equipment type=smart trash can, installation location=3-chome, Ward B, failure contents=communication disconnection, site photograph attached, report date and time=Jun. 1, 2024, site environment=surrounding construction present, weather=rain, request=request for urgent handling” and the like can be cited. Specifically, the generative AI analysis unit executes a multimodal inference engine having a large language model as a core. The generative AI analysis unit receives a text prompt, an image tensor, and a matrix of time-series sensor data as input data. For example, the text prompt is a tokenized integer array. The image tensor is a multidimensional array of normalized pixel values. The generative AI analysis unit projects these heterogeneous data into a common latent space vector. The generative AI analysis unit calculates a correlation between respective modalities using a self-attention mechanism of a transformer. The generative AI analysis unit generates a cause probability distribution of the failure, a text generation result of a recommended countermeasure procedure, and an ID list of related past cases as an output. For example, the output is numerical data indicating that a probability that a cause is a communication module failure is 88 percent, and a natural language text indicating the countermeasure procedure. The generative AI analysis unit passes this output data to a subsequent failure determination unit. Thereby, the system identifies a complex failure cause that cannot be discovered by a single data source. The system exerts a technical effect of dramatically improving accuracy and comprehensiveness of inference. The system is applicable to a failure diagnosis system for complex industrial machinery.

The failure determination unit automatically determines validity of the failure report information and excess or deficiency of information based on an analysis result of the generative AI analysis unit, and classifies whether the failure is a simple failure solvable by a past solution or a complex failure requiring a site investigation or advanced handling. For example, in a case of “installation location is not entered”, “failure contents are ambiguous”, “site photograph is unclear”, “reporter information is not entered”, “site environmental information is insufficient”, “failure occurrence date and time is unknown”, “relevance of simultaneous failures of a plurality of devices is unknown”, or the like, a return notification is automatically transmitted to the reporter as information deficiency. In a case where the information is complete, past similar failure cases are referred to, and whether the failure is the simple failure solvable by the past solution or the complex failure requiring the site investigation or the advanced handling is classified with high accuracy. Specifically, the failure determination unit executes a hybrid determination logic combining a decision tree algorithm and a neural network. The failure determination unit receives a numerical vector indicating the cause probability distribution and an information loss rate output from the generative AI analysis unit as input data. For example, the input data is an array of cause probabilities and a binary array indicating presence or absence of input of essential items. The failure determination unit first determines excess or deficiency of information by a hard rule using the decision tree algorithm. In a case where it is determined that the information is sufficient, the failure determination unit calculates a complexity score using the neural network. The failure determination unit generates a complexity score, which is a continuous value in a range from 0 to 1, and a binary flag indicating simple or complex as an output. For example, the output is a data set in which the complexity score is 0.3 and the flag is 0 indicating simple. The failure determination unit determines subsequent processing routing based on this flag. Thereby, the system achieves both certainty of a rule base and flexibility of machine learning. The system exerts a technical effect of reducing an occurrence rate of rework processing due to erroneous determination to the utmost limit. The system is applicable to a triage system of automatic response type customer support.

The failure classification unit classifies the failure into the simple failure and the complex failure based on a determination result of the failure determination unit, and automatically branches a subsequent processing flow. For example, a failure solvable by restart, firmware update, part replacement, setting change, remote operation, site cleaning, or the like is classified as the simple failure, and a failure requiring a site investigation, equipment replacement, system redesign, network reconstruction, sensor recalibration, site environment improvement, examination of failure ripple prevention measures, or the like is classified as the complex failure. Specifically, the failure classification unit functions as a software switch that executes a dynamic routing algorithm. The failure classification unit receives the binary flag and metadata of the failure transmitted from the failure determination unit as input data. For example, the input data is header information including a flag value of 1 and a failure ID. The failure classification unit reads a bit value of this binary flag. The failure classification unit pushes data to a processing queue for the simple failure in a case where the bit value is 0. The failure classification unit pushes data to a processing queue for the complex failure in a case where the bit value is 1. The failure classification unit generates a status code indicating success of enqueueing to each queue as an output. For example, the output is an integer value of 200 indicating success. The failure classification unit transmits this status code to a log management module. Thereby, the system distributes a load of a subsequent processing module and maximizes parallel processing efficiency. The system exerts a technical effect of improving processing throughput of the entire system. The system is applicable to a load balancer of a large-scale transaction processing system.

The work company selection unit, in a case where the failure is determined to be the simple failure, comprehensively evaluates a plurality of parameters such as past records, supported areas, availability statuses, construction periods, costs, quality evaluations, a past trouble history, and evaluations from reporters of work companies and field technicians using the generative AI, and automatically selects an optimal work company or technician. For example, the selection is performed based on information such as “operator_A has a track record of handling multiple times in the past for a smart trash can in 3-chome, Ward B, and is currently available,” “operator_B has a short construction period for a similar failure,” and “operator_C has a low cost but a low quality evaluation,” and ordering data is automatically generated and automatically transmitted to the work company. Specifically, the work company selection unit executes an evolutionary algorithm for solving a constrained optimization problem. The work company selection unit receives a multidimensional matrix including a parameter group of each work company as input data. For example, this matrix is numerical data in which each row indicates a work company and each column indicates a cost, a construction period, and a quality score. The work company selection unit expresses a combination of each work company as a chromosome. The work company selection unit searches for an optimal solution by repeating crossover and mutation operations. The work company selection unit generates an ID of a work company having the highest fitness function value and details of its evaluation score as an output. For example, the output is data indicating that the work company ID is 1024 and the comprehensive score is 92.5. The work company selection unit passes this ID to the ordering processing unit. Thereby, the system discovers a global optimal solution from a huge number of combinations at high speed. The system exhibits a technical effect of realizing optimal matching while suppressing consumption of computational resources. The system is applicable to an automatic selection system for delivery companies in the logistics industry.

The ordering processing unit automatically generates order contents (failure contents, a site photograph, work instructions, a handling deadline, requests, and the like) for the work company or the technician selected by the work company selection unit, and automatically transmits the order contents to a system of the work company or the technician. For example, specific instructions such as “smart trash can in 3-chome, Ward B, communication disconnection, restart handling, site photograph attached, urgent handling requested” are included. The work company or the technician performs site handling based on the received instructions, and inputs a progress status and a work completion report into the system. Specifically, the ordering processing unit records an ordering transaction on a blockchain using smart contract technology. The ordering processing unit receives the work company ID received from the work company selection unit and text data including the failure contents as input data. For example, the input data is an integer value of the work company ID and character string data of the work instructions. The ordering processing unit generates a cryptographic hash value from this input data. The ordering processing unit generates electronic order form data including this hash value. The ordering processing unit generates an ordering packet to which a digital signature is attached as an output. For example, the output is binary data signed by an RSA algorithm. The ordering processing unit transmits this ordering packet to the system of the work company via a secure communication protocol. Thereby, the system makes it physically impossible to falsify the order contents. The system exhibits a technical effect of ensuring data integrity and non-repudiation in business-to-business transactions. The system is applicable to an automatic ordering platform in supply chain management.

The expert technician assignment unit, in a case where the failure is determined to be the complex failure, comprehensively evaluates expertise, a work load, a past handling history, supportable areas, suitability of technical fields, and the like of expert technicians using the AI, and automatically assigns an optimal expert technician. For example, the selection is performed based on information such as “technician X is familiar with failure analysis of surveillance cameras and has handled many similar complex failures in the past,” “technician Y currently has a high work load and is excluded from assignment,” and “technician Z has abundant experience in handling failures of outdoor equipment,” and the failure contents are automatically notified to a terminal of the technician. The technician implements advanced handling such as a site investigation, detailed failure analysis, equipment replacement, redesign of the entire system, firmware analysis, network reconstruction, sensor recalibration, site environment improvement, and examination of failure propagation prevention measures, and inputs a progress status and a work completion report into the system. Specifically, the expert technician assignment unit executes a multi-class classification task using a support vector machine. The expert technician assignment unit receives a feature vector of the complex failure and a skill vector of each technician as input data. For example, the feature vector is a one-hot encoded array indicating a technical domain of the failure. The expert technician assignment unit maps these vectors to a high-dimensional space using a kernel function. The expert technician assignment unit separates an optimal technician class using a hyperplane. The expert technician assignment unit generates a list of assignment suitability probabilities of each technician as an output. For example, the output is probability data indicating 85 percent for technician X and 60 percent for technician Z. The expert technician assignment unit transmits a push notification to the terminal of the technician with the highest probability. Thereby, the system performs highly accurate matching even for complex skill requirements having non-linear relationships. The system exhibits a technical effect of maximizing an operation rate of highly skilled human resources. The system is applicable to automatic consultation assignment of medical specialists in the medical field.

The progress management unit automatically collects progress reports (site arrival, work start, restart completion, equipment replacement completion, restoration confirmation, site investigation completion, failure analysis completion, firmware update completion, network reconstruction completion, sensor recalibration completion, site environment improvement completion, failure propagation prevention measure implementation completion, and the like) from the work company or the technician, and notifies an administrator or the reporter in real time. A timeline display of the progress status, automatic detection of progress delay, automatic aggregation of the progress reports, a dashboard display of the progress status, automatic report generation of the progress status, and the like are also implemented. Specifically, the progress management unit aggregates real-time data using a stream processing engine. The progress management unit receives a stream of status codes continuously transmitted from the terminal of each technician as input data. For example, the status code is an integer value such as 200 indicating work start or 201 indicating restart completion. The progress management unit calculates a progress rate for each certain period of time using a sliding window method. The progress management unit generates time-series statistical data indicating the progress status of the entire system as an output. For example, the output is structured data indicating a completion rate of 75 percent and the number of delayed projects of 3. The progress management unit caches this statistical data in an in-memory database, and immediately responds to a query from the dashboard. Thereby, the system avoids a disk I/O bottleneck of the database. The system exhibits a technical effect of visualizing statuses of thousands of concurrent tasks with a delay in milliseconds. The system is applicable to operation status monitoring of a large-scale production line.

The history management and learning unit automatically records and accumulates a processing history for each failure, a determination basis, a work company selection reason, a technician assignment reason, a progress status, feedback from the reporter, a work completion report, a past trouble history, a customer satisfaction evaluation, site environmental data, meteorological data, traffic volume data, surrounding construction information, a failure occurrence tendency, a failure occurrence sign, a failure propagation risk, failure handling resource allocation, a failure handling cost, failure handling quality, a failure handling speed, failure handling efficiency, failure handling accuracy, a failure handling automation rate, a failure handling standardization rate, a failure handling optimization rate, and the like, and utilizes them for future retraining of the AI model, business improvement, audit response, failure tendency analysis, preventive maintenance plan formulation, failure occurrence risk evaluation, failure propagation risk evaluation, optimal failure handling resource allocation, failure handling cost reduction, failure handling quality improvement, failure handling speed improvement, failure handling efficiency improvement, failure handling accuracy improvement, failure handling automation rate improvement, failure handling standardization rate improvement, failure handling optimization rate improvement, and the like. Specifically, the history management and learning unit structures the collected wide variety of data and stores it in a large-scale distributed database system. The system uses these accumulated data as an input for a continuous machine learning pipeline. The history management and learning unit extracts data for a certain past period by periodic batch processing. The processing unit divides the extracted data into a learning dataset and a verification dataset. The system executes retraining of a deep learning model. The model adopts, for example, a neural network architecture equipped with a multilayer perceptron or a self-attention mechanism. The history management and learning unit generates a numerical vector including environmental sensor values and meteorological data at the time of failure occurrence as input data. The input data is, for example, a 128-dimensional floating-point number vector composed of elements such as temperature, humidity, precipitation, and wind speed. The processing unit applies a word embedding method to text data to convert it into a 512-dimensional dense vector. The system combines these vectors to generate an integrated feature tensor. The model receives this integrated feature tensor as an input. The model executes a forward propagation operation and outputs a future failure occurrence probability and an optimal resource allocation ratio. The output data is, for example, a floating-point number score in a range of 0.0 to 1.0 indicating a failure occurrence probability within 24 hours for each equipment. In addition, the output data includes an array of integer values indicating the recommended number of personnel assigned to each work group. The history management and learning unit calculates an error between the output predicted value and an actual operation result. The processing unit uses a cross-entropy error or a mean squared error as an error function. The system calculates a gradient of a weight parameter in the network using an error backpropagation method. The processing unit updates the weight parameter using an optimization algorithm. The system saves the updated weight parameter as a new inference model. By automating this retraining process, the system continuously improves the adaptation ability of the model to environmental changes and new failure patterns. The processing unit transmits the output failure occurrence probability score to a preventive maintenance module. The preventive maintenance module automatically issues an inspection instruction for equipment whose score exceeds a preset threshold value. Thereby, the system realizes data-driven and highly accurate preventive maintenance without depending on human rules of thumb. By preventing the occurrence of failures, the system minimizes downtime of urban infrastructure and dramatically improves the operation rate of the entire system.

The user interface unit provides an operation screen for a resident, a field worker, a city administrator, an expert technician, a person in charge of a work company, and the like to perform input of project information, progress confirmation, notification reception, feedback input, and the like. For example, various screens such as a project information input screen, a site photograph or video upload screen, a timeline display of a progress status, a list display of a notification history, a feedback input form, a failure tendency analysis dashboard, and a preventive maintenance proposal screen are provided. The user interface unit also implements an input assistance function, an error check function, a real-time notification function, an automatic completion function of input contents by AI, and the like to enhance user convenience. Specifically, the user interface unit is implemented using an asynchronous communication protocol between a front-end application and a back-end server. The system transmits dynamically generated screen drawing data to a web browser or a dedicated application operating on a user's terminal. Every time the user types characters into an input form, the user interface unit transmits the input character string sequence to a back-end inference server in real time. The inference server is equipped with a lightweight natural language processing model. The model tokenizes the input character string sequence and converts it into an embedding vector. The input data is, for example, an integer array with a maximum length of 64 tokens. Based on this input data, the model predicts a word or phrase that is highly likely to be input next. The model outputs an appearance probability distribution for each token in a vocabulary dictionary as output data. The output data is, for example, a 30,000-dimensional probability value vector. The inference server extracts the top five candidate texts with the highest probability values. The inference server returns the extracted candidate texts to the front end in a structured data format. The user interface unit immediately renders the received candidate texts as a drop-down list on the screen. When the user selects one from the candidates, the system automatically completes the remaining input fields. With this automatic completion function, the processing unit significantly reduces the number of physical keystrokes for input work. The system reduces the occurrence rate of input errors and improves the quality of information accumulated in the database. Furthermore, the user interface unit executes preprocessing on the client side for the uploaded image data. The processing unit resizes the resolution of the image to a standard size and normalizes pixel values. The system transmits the preprocessed image tensor to a back-end image recognition module. Through these technical processes, the system reduces the calculation load on the server side while suppressing the consumption of network bandwidth.

Specific examples of prompt sentences to be read by the generative AI include “Based on the following failure report information and site photograph, search for past similar failure cases and infer an optimal countermeasure method. Failure report information: equipment type=smart trash can, installation location=3-chome, Ward B, failure contents=communication disconnection, site photograph attached, report date and time=Jun. 1, 2024, site environment=surrounding construction present, weather=rain, request=urgent handling requested,” “From the following work company candidates, comprehensively evaluate past records, supported areas, availability statuses, construction periods, costs, quality evaluations, a trouble history, and reporter evaluations, and select an optimal work company. Candidates: operator_A, operator_B, operator_C. Project information: smart trash can in 3-chome, Ward B, communication disconnection, restart handling, site photograph attached, urgent handling requested,” and “From the following expert technician candidates, comprehensively evaluate expertise, a work load, a past handling history, supportable areas, and suitability of technical fields, and select an optimal expert technician. Candidates: technician X, technician Y, technician Z. Project information: surveillance camera in 1-chome, Ward C, video interruption, site investigation required, site photograph attached, request=night work requested.” Specifically, the system includes a prompt generation module that dynamically constructs these prompt sentences. The prompt generation module embeds structured data acquired from the database into a natural language template. The system formats the generated prompt sentence according to an input format of a large language model. The system divides the prompt sentence into three sections: a system instruction, context information, and a user request. The processing unit tokenizes text data in subword units. The processing unit projects a token sequence into a multidimensional embedding vector space. The input data is, for example, an integer array having a length of up to 2048 tokens. The large language model calculates dependencies between input tokens using a self-attention mechanism. The model executes matrix operations in parallel using billions of parameters. The model generates a probability distribution of text tokens indicating an inference result as output data. The system samples the most likely token sequence from the probability distribution to generate a final response text. The output data is, for example, structured text data including a specific work company ID, a step list of recommended countermeasure procedures, and its inference basis. The system executes parsing processing using a regular expression on the output text data. The processing unit extracts necessary parameters from a parsing result and passes them to a subsequent automatic ordering module or notification module. Through this series of processing, the system generates a structured command executable by a computer with high accuracy from a natural language instruction which is unstructured data. The system automatically executes complex determination logic without intervention of a human operator. By utilizing the advanced context understanding ability of the large language model, the system enables flexible and appropriate handling even for exceptional failure situations and ambiguous requests that are difficult to handle with a conventional rule-based system.

### Implementation Steps

Step 1: Input and Acquisition of Failure Report Information

A resident, a field worker, a city administrator, a remote monitoring system, a periodic inspection system, or the like reports a failure regarding equipment such as streetlights, traffic signals, surveillance cameras, environmental sensors, public Wi-Fi access points, smart parking meters, smart trash cans, meteorological observation devices, disaster warning terminals, digital signage, electric bus stop terminals, smart water meters, and smart power meters using various input channels such as a smartphone application, a web portal, an administrator terminal, a field worker tablet, a remote monitoring system API, and a periodic inspection robot. At the time of reporting, an equipment type, an installation location, failure contents, a site photograph or video, reporter information, an occurrence date and time, a detailed failure explanation, site environmental information, presence or absence of a past failure history, special circumstances of the site, requests, and the like are input, and these pieces of information are transmitted to the server in real time. Specifically, the input acquisition unit includes an API gateway that integrally manages data reception from various endpoints. The system asynchronously receives data packets transmitted from each input channel. The processing unit analyzes header information of the received data packet and extracts a payload. The system separates text data, numerical data, and binary data included in the payload. The processing unit executes preprocessing on binary data of an image or a video. The processing unit resizes the image data to a resolution of, for example, 224 pixels square. The processing unit normalizes an RGB value of each pixel to a range of 0 to 1. The processing unit converts the normalized image data into a 3-channel multidimensional tensor. The input data is, for example, a floating-point number tensor having a shape of 224 by 224 by 3. The processing unit performs character code normalization and unnecessary symbol removal on the text data. The system integrates these preprocessed data to generate a standardized report data object. The output data is a structured data object in which each item is defined by a key-value pair. The system enqueues the generated report data object into a message queuing system. By using a message queue, the processing unit prevents server overload due to a sudden large amount of failure reports. The system provides a stable data stream to a subsequent database registration module or AI analysis module. With this asynchronous processing architecture, the system maximizes the throughput of the entire system and realizes high fault tolerance while maintaining real-time performance. By converting input data of various formats into a unified internal representation, the system constructs a foundation on which a subsequent machine learning model can efficiently process data.
Step 2: Database Registration and Management of Failure Report Information

A project database management unit classifies and tags the received failure report information in multiple dimensions such as an equipment type, an installation location, failure contents, a report date and time, a progress status, a reporter attribute, site environmental conditions, a failure occurrence frequency, a past failure history, a handling track record of a work company or a technician, a site photograph or video file, drawing data, site environmental sensor values, meteorological data, and traffic volume data, and stores it in a database. For example, a failure history that occurred in the past with the same equipment type and the same installation location, an occurrence frequency of the same failure contents, multiple reports by the same reporter, simultaneous failures of multiple equipment at the same site, a failure occurrence tendency for each season, a correlation with meteorological conditions, a relevance to surrounding construction, a past handling history, a handling track record of a work company or a technician, a customer satisfaction evaluation, a work completion report, a trouble occurrence history, and the like are also linked and managed. Specifically, the project database management unit adopts a hybrid storage architecture combining a relational database and a graph database. The system dequeues the report data object from the message queue. The processing unit extracts structured attribute data from the report data object and inserts it into a corresponding table of the relational database. At the same time, the processing unit generates nodes and edges on the graph database in order to express complex relationships between data. The system defines equipment, a location, a reporter, failure contents, and the like as independent nodes, respectively. The system connects these nodes with edges indicating relationships. The processing unit executes a clustering algorithm in order to automate multidimensional classification and tagging. The system groups failure reports that are geographically and temporally close to each other using, for example, a density-based spatial clustering algorithm. The input data is a group of three-dimensional numerical vectors including a latitude, a longitude, and a timestamp of an occurrence time of each report. The algorithm calculates a Euclidean distance between the respective vectors, and determines data points densely gathered within a certain threshold value as the same cluster. The output data is a unique cluster ID assigned to each report data. The system adds this cluster ID as an index of the database. By using the cluster ID, the processing unit shortens an execution speed of a query in subsequent similar failure search or tendency analysis to a logarithmic time order. By executing a traversal query of the graph database, the system instantly extracts simultaneous failures of multiple equipment at the same site or a hidden correlation between specific meteorological conditions and failure occurrence. With this advanced data structuring and index creation, the system maintains a state in which necessary information can be searched in milliseconds from a huge amount of history data. By optimizing a physical storage method of data, the system eliminates an IO bottleneck of storage and dramatically improves response performance of the entire system.
Step 3: AI Analysis of Failure Report Information and Information Deficiency

Determination A generative AI analysis unit receives various data such as failure report information, a site photograph, a video, site environmental data, weather data, traffic volume data, handling records of work companies and technicians, customer satisfaction evaluations, work completion reports, and trouble occurrence histories as input, performs analysis by combining a plurality of AI technologies such as a natural language processing model, an image recognition model, an anomaly detection model, a time series analysis model, a clustering model, a causal inference model, and a risk evaluation model, automatically detects omissions and inconsistencies in text information, unclarity of the site photograph and the video, lack of site environmental information, unclarity of a failure occurrence date and time, unclarity of relevance of simultaneous failures of a plurality of devices, and the like, and automatically transmits a return notification to a reporter if there is an information deficiency. As a specific example of a prompt sentence to be read by the generative AI, “Based on the following failure report information and site photograph, detect omissions and inconsistencies in input information, and point out any deficiency. Failure report information: equipment type=smart trash can, installation location=3-chome, Ward B, failure contents=communication disconnection, site photograph attached, report date and time=Jun. 1, 2024, site environment=surrounding construction present, weather=rain, request=immediate handling desired” is given. Specifically, the generative AI analysis unit executes a multimodal neural network architecture. The system constructs an integrated pipeline for simultaneously processing text data and image data. The processing unit inputs the text data into the natural language processing model and extracts a context vector. The processing unit inputs the image data into a convolutional neural network and extracts a spatial feature map. The input data is, for example, a 512-dimensional text context vector and a 2048-dimensional image feature vector. The system integrates these vectors in a concatenation layer to generate a 2560-dimensional multimodal feature vector. The model inputs this integrated vector into a fully connected layer and determines presence or absence of the information deficiency. The model outputs a deficiency probability score for each required input item as output data. The output data is an array of floating-point numerical values in a range of 0.0 to 1.0, such as “photograph unclarity probability 0.85” and “position information missing probability 0.12”. The system compares each output score with a preset threshold value. The processing unit sets an information deficiency flag to true in a case where any of the scores exceeds the threshold value. In a case where the information deficiency flag is true, the system automatically generates a return message including a specific missing item name and an instruction for re-input. The system transmits the generated message as a push notification to a terminal of the reporter via an API. By this automatic determination process, the system completely eliminates effort of a human administrator visually checking contents. The system prevents incomplete data from being mixed into subsequent processing processes, and maintains inference accuracy and processing efficiency of the entire system. By the multimodal analysis, the system mutually complements information that is not described in the text but can be read from the image, and a reverse pattern thereof, and realizes extremely highly accurate deficiency determination.
Step 4: Similar Failure Search and Countermeasure Method Inference by AI for Failure Contents The generative AI analysis unit receives a plurality of elements such as an equipment type, an installation location, failure contents, a site photograph, a video, a past failure history, a failure occurrence frequency, site environmental conditions, a reporter attribute, an occurrence date and time, a detailed failure explanation, a site environmental sensor value, weather data, traffic volume data, surrounding construction information, a past handling history, handling records of work companies and technicians, customer satisfaction evaluations, work completion reports, and trouble occurrence histories as input, searches a database for past similar failure cases, performs pattern recognition, statistical inference, anomaly detection, time series analysis, clustering, causal inference, and risk evaluation, and classifies whether the failure is a simple failure solvable by a past solution or a complex failure requiring a site investigation or advanced handling with high accuracy. As a specific example of a prompt sentence to be read by the generative AI, “Based on the following failure report information and site photograph, search for past similar failure cases and infer an optimal countermeasure method. Failure report information: equipment type=smart trash can, installation location=3-chome, Ward B, failure contents=communication disconnection, site photograph attached, report date and time=Jun. 1, 2024, site environment=surrounding construction present, weather=rain, request=immediate handling desired” is given. Specifically, the generative AI analysis unit executes a neighborhood search algorithm in a high-dimensional vector space. The system inputs the input current failure report data into an encoder model and generates a fixed-length query vector. The input data is a 1024-dimensional dense vector integrating text, numerical values, and categorical variables. The system calculates a cosine similarity with the query vector for a group of past failure case vectors accumulated in a vector database. The processing unit extracts top 10 past cases having highest similarity scores from among millions of records in milliseconds using an approximate nearest neighbor search algorithm. The system aggregates solution labels of the extracted past cases. The model integrates these similar case data and current environmental data, and inputs them into a classification network. The model outputs a suitability probability distribution for each countermeasure category as output data. The output data is an array of probability values such as “recovery probability by restart 0.92”, “necessity probability of part replacement 0.05”, and “necessity probability of detailed site investigation 0.03”. The system selects a countermeasure category with the highest probability. The processing unit assigns a simple failure flag to the project in a case where the selected countermeasure is of a nature to be completed by a remote operation or a simple work. The processing unit assigns a complex failure flag in a case where a professional diagnosis or a physical equipment replacement is involved. The system transmits this inference result and flag information to a subsequent priority determination module and resource allocation module. By using vector operations in a high-dimensional space, the system realizes a highly accurate search based on semantic similarity independent of keyword matching. The system instantaneously applies a vast amount of past experiential knowledge to a current judgment, and determines an initial policy for failure handling more quickly and accurately than a human.
Step 5: Failure Classification and Priority Determination A failure determination unit and a failure classification unit classify whether the failure is the simple failure solvable by a restart, a firmware update, a part replacement, a setting change, a remote operation, site cleaning, or the like, or the complex failure requiring a site investigation, an equipment replacement, a system redesign, a network reconstruction, a sensor recalibration, a site environment improvement, consideration of a failure spread prevention measure, or the like based on an inference result of the generative AI analysis unit, and further automatically determine a priority of the failure in consideration of site urgency, a failure occurrence frequency, a degree of critical infrastructure, a past claim history, a request of a reporter, site environmental conditions, a failure spread risk, and the like. Specifically, the failure determination unit and the failure classification unit execute a gradient boosting tree algorithm which is a decision tree ensemble learning model. The system receives flag information of the simple failure or the complex failure output from a preceding module. The processing unit combines various quantitative features acquired from a database in addition to this flag information to construct a feature vector. The input data is a 64-dimensional numerical vector including, for example, an integer value from 1 to 5 indicating a degree of urgency, an integer value indicating the number of failure occurrences in the past month, a floating-point number indicating an importance score of a target equipment, and a probability value indicating a spread risk to surroundings. The model receives this feature vector as input and sequentially evaluates a plurality of decision trees. The model calculates a final priority score by weighting and adding output values of the respective decision trees. The output data is a priority score which is a continuous value in a range of 0.0 to 100.0. The output data is mapped to a category such as “highest priority handling” if the score is 85.5, and “normal handling” if the score is 42.0, for example. The system writes the calculated priority score as a property of a project data object. The processing unit dynamically rearranges an order of projects in a processing waiting queue based on the priority score. In a case where an urgent project having an extremely high score is detected, the system bypasses a normal queue and assigns the project to a dedicated thread for immediate processing. The system passes this priority score and classification result as parameters to a subsequent work company selection module and expert technician assignment module. By performing a multifaceted risk evaluation using a machine learning model, the system accurately evaluates complex factors that a human operator tends to overlook. The system minimizes damage expansion of the entire urban infrastructure by automatically and optimally concentrating limited handling resources on the most critical failure.
Step 6: Automatic Selection of Work Company and Ordering Processing for Simple Failure In a case where the failure is determined to be the simple failure, a work company selection unit comprehensively evaluates a plurality of parameters such as past records, supported areas, availability statuses, construction periods, costs, quality evaluations, a past trouble history, and evaluations from reporters of work companies and field technicians using the generative AI, and automatically selects an optimal work company or technician, and an ordering processing unit automatically generates order contents (failure contents, a site photograph, a work instruction, a handling deadline, request items, and the like) for the selected work company or technician, and automatically transmits the order contents to a system of the work company or the technician. As a specific example of a prompt sentence to be read by the generative AI, “From among the following work company candidates, comprehensively evaluate past records, supported areas, availability statuses, construction periods, costs, quality evaluations, trouble histories, and reporter evaluations, and select an optimal work company. Candidates: operator_A, operator_B, operator_C. Project information: smart trash can in 3-chome, Ward B, communication disconnection, restart handling, site photograph attached, immediate handling desired” is given. Specifically, the work company selection unit executes a hybrid inference engine combining a constrained optimization algorithm and a reinforcement learning model. The system acquires a list of currently operable work companies and their respective attribute data from a database. The processing unit digitizes the attribute data of each work company and generates a candidate feature matrix. The input data is, for example, an M-by-N floating-point number matrix in which each row represents one work company and each column represents a parameter such as a cost, a distance, and an evaluation score. The model receives this matrix and a current project feature vector as input. The model calculates a suitability score for each work company. The model outputs a unique ID of a work company having the highest suitability score and an array of weighting coefficients indicating a selection reason thereof as output data. The output data is structured data such as “optimal work company ID: 789, selection reason: distance score 0.8, cost score 0.9”, for example. The system passes the selected work company ID to the ordering processing unit. The ordering processing unit dynamically generates an electronic order form object including detailed information of the project and a work instruction in a JSON format. The system transmits the generated JSON payload as an HTTP POST request to an external system of the target work company via a RESTful API. The system confirms completion of ordering by receiving a response of a status code 200 to the transmission. By this series of processing, the system shortens a lead time from failure occurrence to ordering completion to a unit of seconds. By mathematically optimizing a trade-off between cost and quality, the system simultaneously achieves efficiency improvement of ordering work and improvement of handling quality.
Step 7: Automatic Assignment and Notification of Expert Technician for Complex Failure In a case where the failure is determined to be the complex failure, an expert technician assignment unit comprehensively evaluates expertise, a work load, a past handling history, supportable areas, suitability of technical fields, and the like of expert technicians using the generative AI, automatically assigns an optimal expert technician, and automatically notifies a terminal of the technician of failure contents. As a specific example of a prompt sentence to be read by the generative AI, “From among the following expert technician candidates, comprehensively evaluate expertise, a work load, a past handling history, supportable areas, and suitability of technical fields, and select an optimal expert technician. Candidates: technician X, technician Y, technician Z. Project information: surveillance camera in 1-chome, Ward C, video interruption, site investigation required, site photograph attached, request=night work desired” is given. Specifically, the expert technician assignment unit executes a matching algorithm using a graph neural network. The system constructs graph structure data in which skill sets, current position information, and schedules of technicians are nodes, and relationships thereof are edges. The processing unit adds a requirement of the complex failure to the graph as a new node. The input data is a matrix indicating a feature of each node and an adjacency matrix indicating a connection relationship between nodes. The model repeats a message passing process a plurality of times and updates a hidden state vector of each node. The model calculates an inner product of the hidden state vectors of the failure node and each technician node, and calculates a matching score. The model outputs an array of suitability scores in a range of 0.0 to 1.0 for each expert technician as output data. The output data is a numerical list such as “technician X: 0.95, technician Y: 0.42, technician Z: 0.68”, for example. The system extracts an ID of a technician who has acquired the highest score. The processing unit accesses a schedule management database of the technician based on the extracted technician ID, and automatically blocks a necessary work time. The system generates a notification payload including detailed information of the failure, latitude and longitude data of the site, and a recommended investigation procedure. The system transmits a real-time push notification to a mobile terminal of the selected technician using a WebSocket communication protocol. Upon receiving an acceptance response from the technician, the system updates a status of the project to “technician assigned”. The system instantaneously assigns the most suitable personnel based on a mathematical basis for a complex failure requiring advanced expertise. The system prevents a mismatch of human resources and significantly shortens a resolution time of a highly difficult failure.
Step 8: Progress Management, Notification, and Feedback Collection A progress management unit automatically collects progress reports (site arrival, work start, restart completion, equipment replacement completion, recovery confirmation, site investigation completion, failure analysis completion, firmware update completion, network reconstruction completion, sensor recalibration completion, site environment improvement completion, failure spread prevention measure implementation completion, and the like) from work companies and technicians, notifies administrators and reporters in real time, and executes timeline display of progress statuses, automatic detection of progress delays, automatic aggregation of progress reports, dashboard display of progress statuses, automatic report generation of progress statuses, and the like, and a notification/feedback unit also collects feedback and questionnaire results from customers and reporters. Specifically, the progress management unit strictly manages a status transition of each project using a finite state machine model. The system continuously listens to a state update event transmitted from a terminal of a work company at an API endpoint. The input data is an event payload in a JSON format including a project ID, a new status code, and a timestamp. The processing unit updates a state flag in a database based on the received event. The system executes a time series anomaly detection algorithm and monitors a progress delay. The model employs a long short-term memory network learned from required time data of past similar projects. The model receives a current status and an elapsed time as input, and calculates a transition predicted time to a next status. The model outputs an anomaly score indicating a degree of divergence between the predicted time and an actual time as output data. The output data is, for example, a floating-point number in a range of 0.0 to 1.0. The system sets a progress delay flag to true in a case where the anomaly score exceeds a threshold value. When the delay flag is detected, the processing unit automatically renders a warning alert on an administrator dashboard and triggers an escalation process. Every time the state is updated, the system push-delivers a state change notification to terminals of related administrators and reporters using a publish-subscribe messaging model. Upon receiving a work completion status, the system activates the notification/feedback unit. The notification/feedback unit transmits a message including a URL of a dynamically generated questionnaire form to the reporter. The system receives an input evaluation score and text comment, and executes sentiment analysis using a natural language processing model. The system links these quantitative and qualitative data to a project record and stores them in a database. By combining real-time tracking and predictive monitoring, the system prevents work from becoming a black box, and dramatically improves transparency and certainty of project management.
Step 9: History Management, Continuous Learning of AI Model, and Trend Analysis A history management/learning unit automatically records and accumulates a processing history for each failure, a determination basis, a work company selection reason, a technician assignment reason, a progress status, feedback from a reporter, a work completion report, a trouble occurrence history, a customer satisfaction evaluation, site environmental data, weather data, traffic volume data, surrounding construction information, a failure occurrence trend, a failure occurrence sign, a failure spread risk, failure handling resource allocation, a failure handling cost, failure handling quality, a failure handling speed, failure handling efficiency, failure handling accuracy, a failure handling automation rate, a failure handling standardization rate, a failure handling optimization rate, and the like, and utilizes them for future re-learning of an AI model, business improvement, audit response, failure trend analysis, preventive maintenance plan formulation, failure occurrence risk evaluation, failure spread risk evaluation, optimal allocation of failure handling resources, failure handling cost reduction, failure handling quality improvement, failure handling speed improvement, failure handling efficiency improvement, failure handling accuracy improvement, failure handling automation rate improvement, failure handling standardization rate improvement, failure handling optimization rate improvement, and the like. Specifically, the history management/learning unit employs a data lake architecture and integrally accumulates structured data and unstructured data. The system activates an automated batch learning pipeline on a daily or weekly schedule. The processing unit extracts latest operation record data from the data lake, and executes data cleansing and normalization. The system converts the extracted data into a pair of a feature matrix and a correct label vector. The input data is, for example, a multidimensional tensor consisting of tens of thousands of project records. The system generates a clone of a currently operating inference model, and executes additional learning using this input data. The model outputs a predicted value by a forward propagation operation, and calculates a loss function between the predicted value and a correct label which is an actual operation result. The processing unit uses, for example, a cross entropy error or a mean absolute error as the loss function. The system calculates a gradient of each layer in a network using an error backpropagation method, and fine-tunes a weight parameter by an optimization algorithm such as a stochastic gradient descent method. The model outputs a model file including a group of millions of updated weight parameters as output data. The system performs accuracy evaluation of the updated model using a verification dataset. In a case where an accuracy index exceeds a baseline, the processing unit automatically executes hot-swap deployment of the model to an inference server in a production environment. The system recalculates a future failure occurrence probability for infrastructure equipment of the entire city using the updated model. The system automatically generates a list of equipment requiring preventive maintenance and a recommended inspection schedule based on a calculation result. The system completely automates this cycle of continuous integration and continuous delivery. The system self-evolves inference accuracy every time operation is repeated, and permanently improves an adaptive capability of the system to secular changes in an environment and unknown failure patterns.

### Specific Use Case

For example, a case is assumed where a communication disconnection occurs in a smart trash can installed in a residential area of a city, and remaining amount information is no longer transmitted to a city management system. In this case, a resident or a field worker inputs failure report information using a smartphone application. On a report screen, a smart trash can as an equipment type, “3-chome, Ward B” as an installation location, “communication disconnection” as failure contents, an appearance photograph of the smart trash can as a site photograph, a name and contact information as reporter information, an occurrence date and time, “communication is suddenly interrupted and a remaining amount cannot be confirmed by a management system” as a detailed failure explanation, “road construction is being implemented in surroundings” as site environmental information, “immediate handling desired” as a request item, and the like are input. These pieces of information are transmitted to a server via a failure report information acquisition unit. Specifically, the failure report information acquisition unit receives an HTTP POST request from the smartphone application at an endpoint. The system parses multipart form data from raw data of the received request. The processing unit extracts a value of a text input field and constructs a payload in a JSON format. The input data is, for example, a structured object in which a character string “smart_trash_can” is assigned to a “device_type” key. At the same time, the processing unit extracts binary data of the attached appearance photograph. The processing unit executes a virus scan and a validation check of a file format on the image data. The processing unit expands the image data on a memory and converts it into a character string in a base64 encoding format, or stores it in an object storage and acquires a reference URI thereof. The system integrates these text data and the image reference URI, and generates a single report event object. The output data is a data record to which a UUID uniquely identifiable inside the system is assigned. The system enqueues the generated report event object into an in-memory message queue. The processing unit asynchronously delivers data to a subsequent database management module and AI analysis module using a publish-subscribe mechanism of the message queue. The system completes data collection and initial processing from this edge device in milliseconds. Even in a case where a network delay or a temporary disconnection occurs, the system completely prevents data loss and duplication by retry control on a client side and idempotent reception processing on a server side. The system reliably captures an event occurring in a physical world as highly accurate digital data processable by a computer.

A project database management unit classifies the received information by an equipment type, an installation location, failure contents, a report date and time, site environmental conditions, a past failure history, a site photograph, a reporter attribute, and the like, and stores them in a database. The generative AI analysis unit receives the received failure report information, site photograph, and site environmental data as input, detects omissions and inconsistencies in text information by a natural language processing model, analyzes presence or absence of an appearance abnormality, an installation deviation, and an external damage from the site photograph by an image recognition model, and infers a trend and a cause of failure occurrence from the site environmental data and the past failure history by an anomaly detection model. For example, in a case where there are many cases where a communication disconnection occurred in the same installation location in the past and was recovered by a restart, the AI infers that the failure can be solved by a restart this time as well. As a specific example of a prompt sentence to be read by the generative AI, “Based on the following failure report information and site photograph, search for past similar failure cases and infer an optimal countermeasure method. Failure report information: equipment type=smart trash can, installation location=3-chome, Ward B, failure contents=communication disconnection, site photograph attached, report date and time=Jun. 1, 2024, site environment=surrounding construction present, request=immediate handling desired” is set. Specifically, the project database management unit and the generative AI analysis unit closely cooperate to execute a parallel processing pipeline. The system activates an AI inference engine in parallel with writing processing to the database. The processing unit inputs an image tensor of the site photograph into a convolutional neural network. The model extracts a feature map of an edge and a texture in an image through a plurality of convolutional layers and pooling layers. The model outputs a probability score of an appearance abnormality and coordinate data of a bounding box indicating an abnormal part as output data. At the same time, the processing unit inputs text data into a transformer-based language model and generates an embedding vector of a context. The input data is a multidimensional tensor combining an image feature vector and a text embedding vector. The system issues a similarity search query to a vector database using this integrated tensor. The system acquires a solution label of a past similar case. The model synthesizes these pieces of information and calculates a probability distribution of a final countermeasure plan. The output data is an output value of a softmax function such as a probability of a “restart” class being 0.88 and a probability of a “module replacement” class being 0.12, for example. The system adopts a class having a maximum probability as an optimal countermeasure. The processing unit packages the inferred countermeasure plan and an ID list of similar cases serving as a basis thereof as an inference result object in a JSON format. The system passes this inference result object to a subsequent failure determination unit and work company selection unit. By integrating multimodal analysis of an image and text, the system accurately specifies a minute abnormality and a complex cause that may be overlooked by a single data source, and dramatically improves reliability of inference.

The failure determination unit and the failure classification unit classify the failure as a simple failure solvable by a restart based on an inference result of the AI, and the work company selection unit automatically selects a work company that has past records of handling multiple times for a smart trash can in 3-chome, Ward B in the past and currently has an availability status using the AI. The ordering processing unit automatically generates order contents such as “smart trash can in 3-chome, Ward B, communication disconnection, restart handling, site photograph attached, urgent handling desired”, and automatically transmits the order contents to a system of the work company. The work company dispatches a worker to a site, executes restart work, and inputs a work completion report to the system. The progress management unit collects progress such as site arrival, work start, restart completion, and restoration confirmation in real time, and notifies an administrator and a reporter. The history management and learning unit records and accumulates an entire history from the current failure report to completion of handling, a determination basis, a work company selection reason, a progress status, the work completion report, feedback from the reporter, and the like, and utilizes them for future re-learning of an AI model, failure tendency analysis, and preventive maintenance plan formulation. Specifically, the present system forms a data flow based on a microservice architecture among the series of these modules. The present failure determination unit evaluates a probability score in an inference result object received from a preceding stage, and sets a simple failure flag to true. The present work company selection unit is activated using this flag as a trigger, and issues a spatial search query to a database. The present input data is latitude and longitude coordinates of a failure occurrence point and an identifier of a required skill set. The present processing unit acquires a list of work companies matching conditions, and determines an optimal one company using a reinforcement learning model. The present output data is a unique ID of the selected work company. The present ordering processing unit calls an API for ordering using this ID, and transmits electronic order form data. The present system receives a callback of order acceptance from the system of the work company. The present progress management unit continuously monitors GPS coordinate data and a status update event transmitted from a mobile terminal of the worker. The present input data is a JSON payload including a time stamp and a status code. The present processing unit overwrites a record in the database every time the status is updated, and synchronizes display of a front-end screen via WebSocket. When receiving a work completion status, the present system closes a series of transactions. The present history management and learning unit combines all input data related to this transaction, an intermediate tensor of an inference process, an output probability score, and a final work result to generate one huge learning data record. The present output data is a multidimensional vector with a correct answer label used in a next batch learning pipeline. By this end-to-end automation, the present system completely eliminates delays and errors caused by human intervention, and shortens a cycle time from failure occurrence to restoration to the utmost limit.

Further, for example, in a case where a video interruption occurs in a surveillance camera installed at an intersection in a city center, and heavy rain, strong wind, or large-scale construction is performed in the surroundings as a site environment, a field worker makes a failure report from a tablet terminal, and attaches a site photograph, a video, meteorological data, and construction information. The AI refers to a failure history that occurred under similar meteorological conditions and construction situations in the past, infers countermeasures such as equipment replacement, cable reconnection, and site environment improvement, and in a case of determining as a complex failure, automatically assigns an expert technician familiar with surveillance camera failure analysis, and instructs a site investigation and detailed analysis. As a specific example of a prompt sentence to be read into the generative AI, “Based on the following failure report information, site photograph, meteorological data, and construction information, search for past similar failure cases and infer an optimal countermeasure method. Failure report information: equipment type=surveillance camera, installation location=city center intersection, failure contents=video interruption, site photograph attached, meteorology=heavy rain/strong wind, construction information=large-scale construction in progress in surroundings, request=night work desired” is set. Specifically, the present system executes an advanced inference pipeline that integrally analyzes multimodal data including dynamically changing environmental factors. The present processing unit extracts a frame sequence from the attached video data, inputs it into a three-dimensional convolutional neural network, and extracts spatiotemporal feature amounts. The present processing unit inputs time-series data of the meteorological data and the construction information into a recurrent neural network, and extracts dynamic feature amounts of environmental changes. The present input data is, for example, a frame tensor of a video and a time-series array of wind speed and precipitation. The present system combines these feature amount vectors to generate a high-dimensional integrated context vector. The present model performs a neighborhood search in a latent space of past complex failure patterns using this integrated vector. The present model outputs a probability distribution of a root cause of the failure and a complex failure flag as output data. The present output data is numerical data such as “physical cable disconnection probability 0.75” and “short circuit probability due to water immersion 0.20”, for example. When determining that the complex failure flag is true, the present system transmits a trigger signal to the present expert technician assignment module. The present processing unit specifies a required expert skill code based on the inferred cause probability distribution. The present system searches a database of technicians having the corresponding skill code, and determines an optimal technician in consideration of current position information and a schedule. The present system automatically transmits a detailed work instruction document including the inferred cause and a recommended investigation procedure to a terminal of the selected technician. By incorporating not only static equipment information but also dynamic environmental data and time-series data into an AI model, the present system accurately diagnoses a failure due to complex factors unpredictable by a simple rule base. The present system automates appropriate personnel placement to a site requiring advanced expertise, and prevents prolongation of downtime.

In this way, the automatic processing system for urban infrastructure failure countermeasures of the present invention automates from a failure report for various IoT devices and communication equipment in a city to automatic determination of information deficiency, automatic collation with a past history, failure classification, automatic selection and ordering of a work company or a technician, progress management, history management, and AI learning in an integrated manner, and realizes operational efficiency improvement of urban infrastructure, speeding up of failure handling, optimal allocation of human resources, reduction of operational costs, improvement of service quality to city residents, and strengthening of resilience of the entire city. Specifically, the entire present system functions as an integrated architecture in which a plurality of machine learning models and data processing modules operate asynchronously and cooperatively on a distributed computing environment. The present system maintains loose coupling among the modules by passing a standardized JSON format data object between respective processing steps. The present system dynamically scales out or scales in containerized inference nodes on a cloud in accordance with a traffic volume of input failure report data. The present input data is time-series metrics indicating a CPU usage rate, a memory consumption amount, and the number of retentions in a message queue of the entire system. The present orchestration engine monitors these metrics and automatically optimizes resource allocation. The present system generates logs of system performance indicators and processing latency of each module as output data. By continuously analyzing these log data, the present system specifies a bottleneck and executes self-repair and performance tuning of the system itself. The present system completely replaces non-technical and error-prone processes such as manual data input, visual confirmation, and contact coordination by telephone or email by a human operator with strict computer processing based on high-dimensional vector operations and probabilistic inference. By continuously updating weight parameters of an inference model using accumulated operational data, the present system autonomously improves determination accuracy and processing efficiency over time. By these technical improvements, the present system minimizes downtime at the time of failure occurrence to a mathematical limit in a modern complex urban infrastructure composed of a huge number of IoT devices. The present system most effectively allocates limited computational resources and human resources, and provides a next-generation infrastructure management platform that firmly supports continuity and stability of urban functions.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

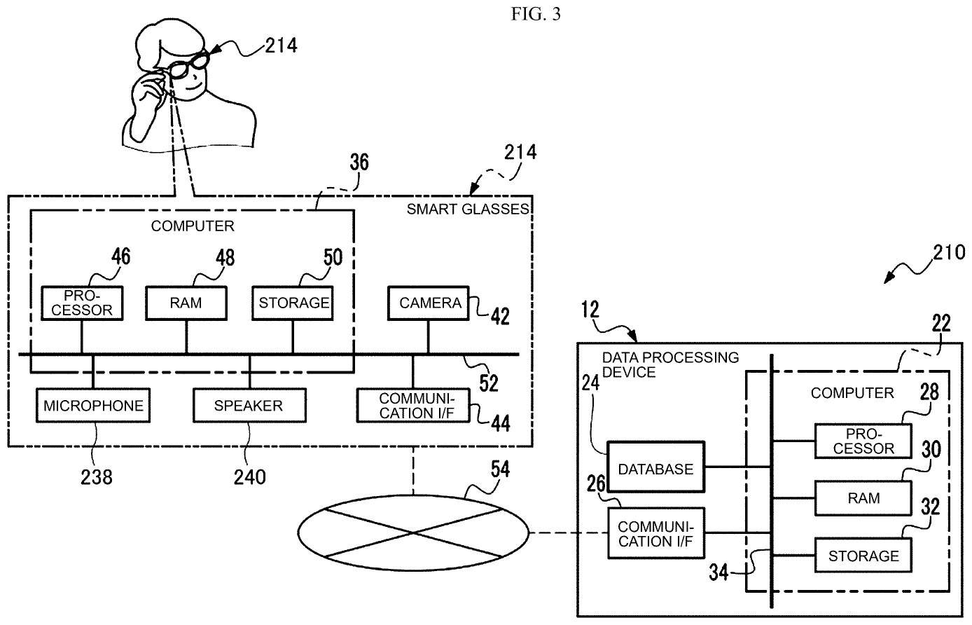

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

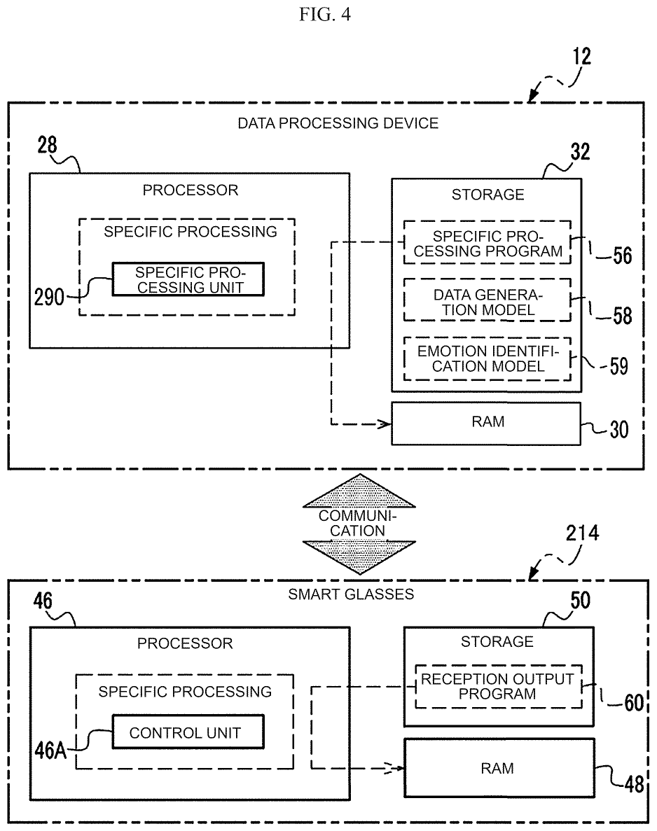

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

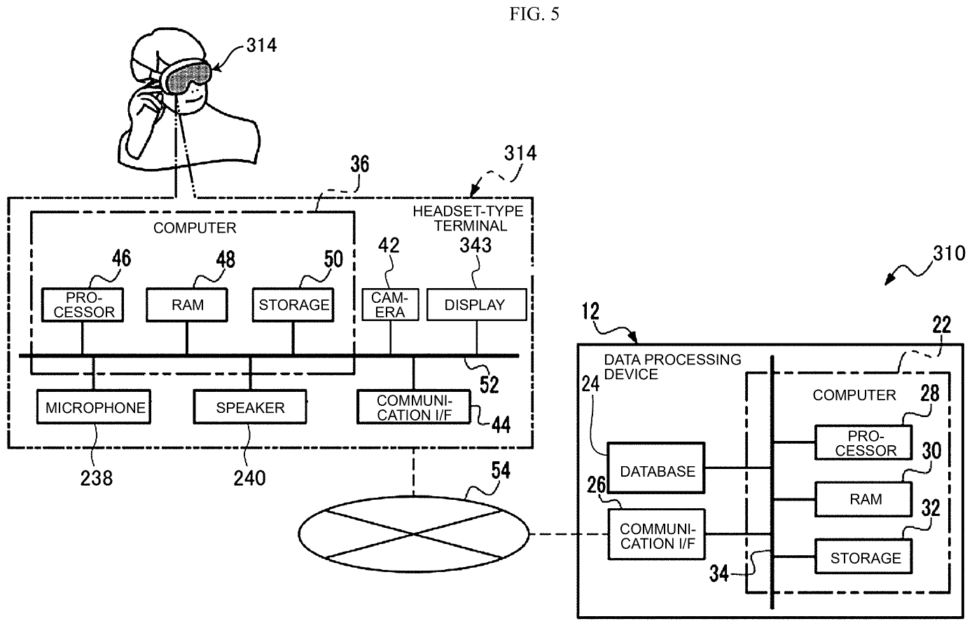

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

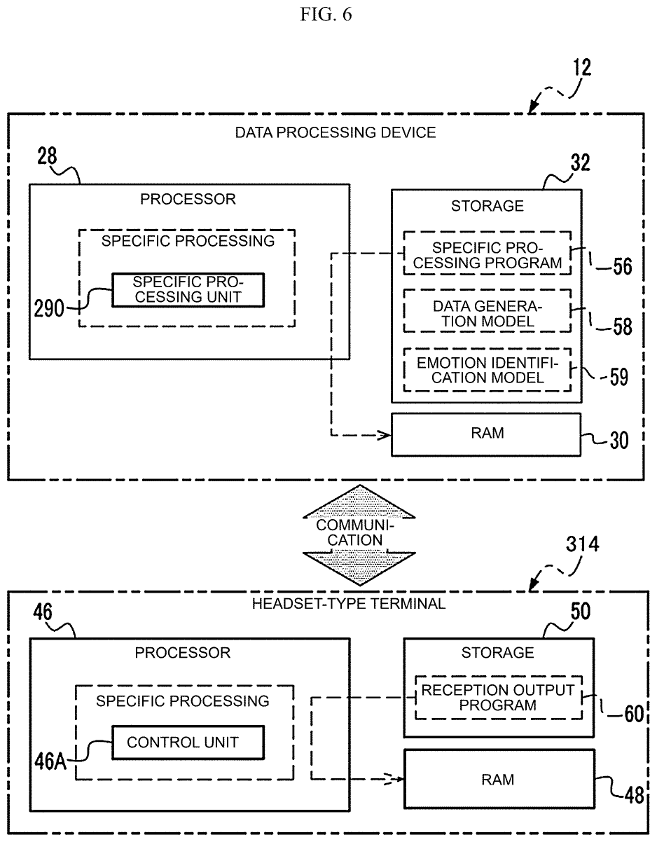

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

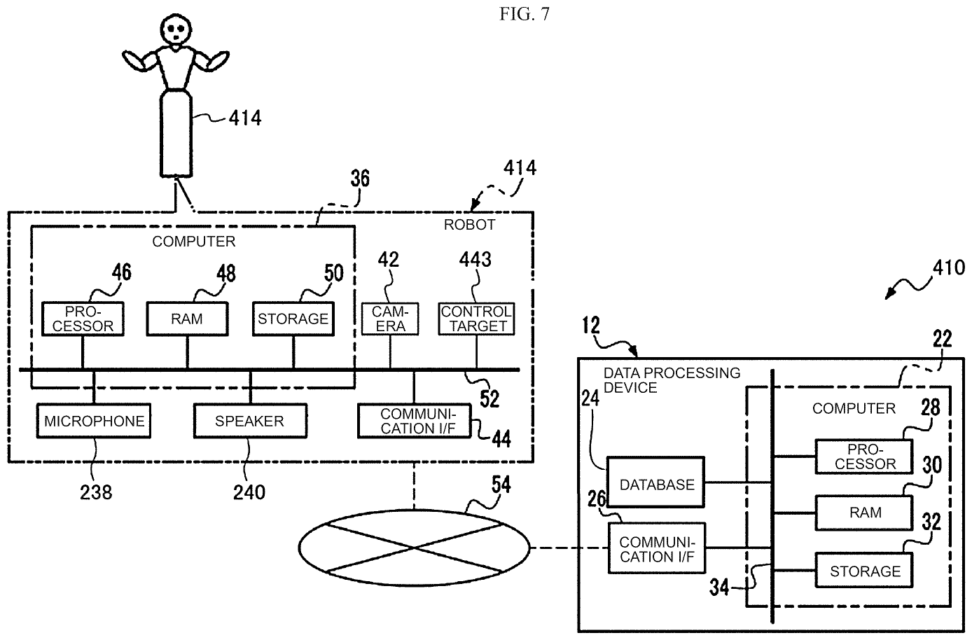

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

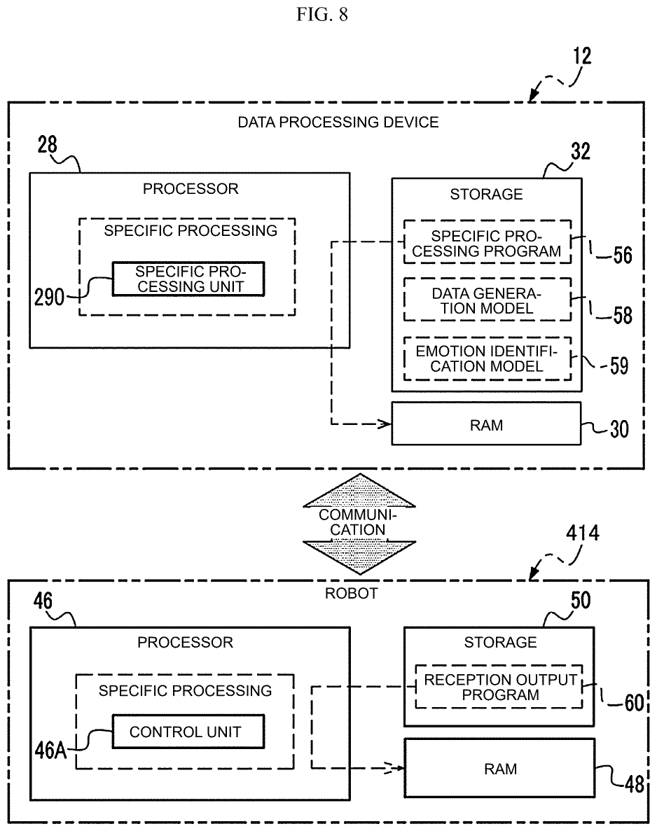

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

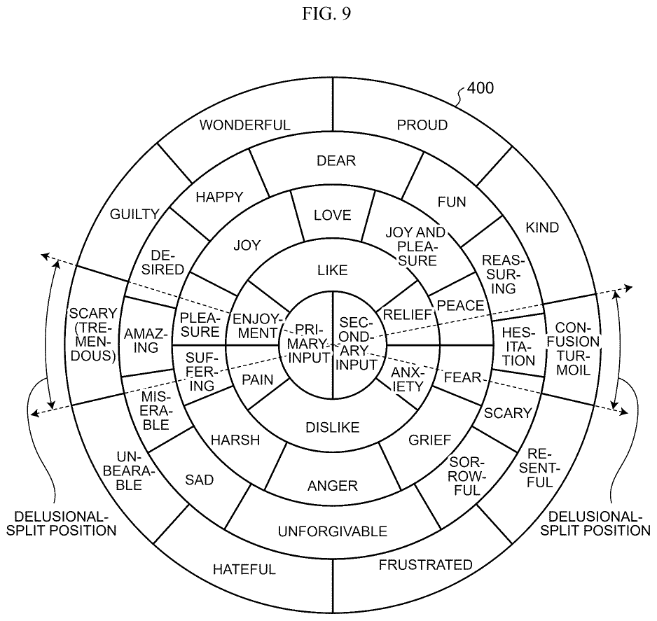

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

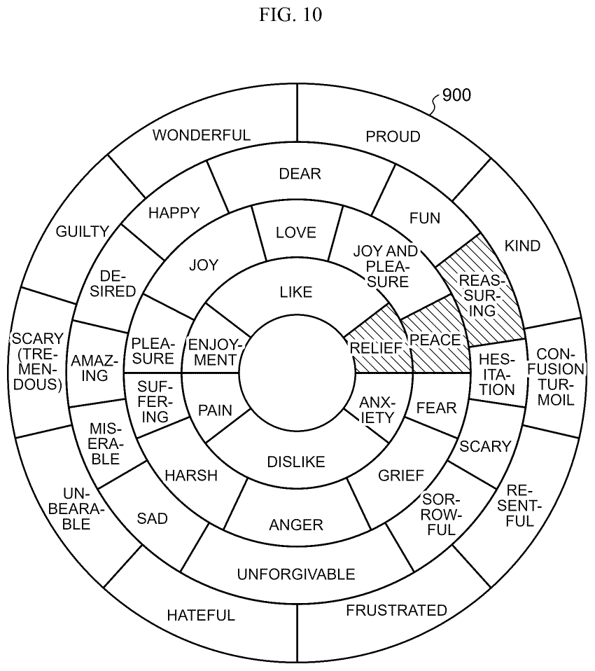

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

An automatic processing system for urban infrastructure failure countermeasures comprising: a failure report information acquisition unit; a failure determination unit; and a failure handling processing unit, wherein the failure report information acquisition unit is configured to receive information such as an equipment type, an installation location, failure contents, a site photograph, a video, reporter information, an occurrence date and time, and a detailed failure explanation as failure report information regarding urban infrastructure equipment such as streetlights, traffic signals, surveillance cameras, environmental sensors, and public Wi-Fi access points from a resident or an administrator; the failure determination unit is configured to collate the received failure report information with a past failure history database using generative AI, analyze presence or absence of similar cases of the same equipment type, the same installation location, and the same failure contents and clarity of solutions from multiple perspectives, automatically determine presence or absence of information deficiency, and classify whether the failure is a simple failure solvable by a past solution or a complex failure requiring a site investigation or advanced handling; and the failure handling processing unit is configured to, based on a determination result of the failure determination unit, automatically execute selection of a work company or a field technician and ordering processing using the generative AI in a case of the simple failure, perform automatic assignment of an expert technician in a case of the complex failure, and further automatically perform a return notification to the reporter in a case where the information deficiency of the failure report information is determined.

### Supplementary Note 2

The automatic processing system for urban infrastructure failure countermeasures according to Supplementary Note 1, wherein the failure determination unit is configured to execute processing of inputting a plurality of elements such as the equipment type, the installation location, the failure contents, the site photograph, the video, a past failure history, a failure occurrence frequency, site environmental conditions, a reporter attribute, the occurrence date and time, and the detailed failure explanation into a machine learning model of the generative AI, automatically inferring an optimal countermeasure method for each failure, and classifying whether the failure is the simple failure or the complex failure with high accuracy.

### Supplementary Note 3

The automatic processing system for urban infrastructure failure countermeasures according to Supplementary Note 1, wherein the failure handling processing unit is configured to execute processing of: in a case where the failure is determined to be the simple failure, comprehensively evaluating a plurality of parameters such as past records, supported areas, availability statuses, construction periods, costs, quality evaluations, a past trouble history, and evaluations from reporters of work companies and field technicians using the generative AI, automatically selecting an optimal work company or technician to generate ordering data, and further automatically transmitting order contents to the work company or the technician; while in a case where the failure is determined to be the complex failure, automatically assigning the expert technician in consideration of expertise, a work load, a past handling history, supportable areas, suitability of technical fields, and the like of the expert technician, and notifying the failure contents.

What is claimed is:

1. A system comprising:
circuitry configured to:
receive, via a communication interface coupled to a packet-switched network, project description data from a terminal device comprising facility configuration parameters, environmental condition parameters, and specification document data, and store the project description data in a storage device;
apply a natural language processing model to the project description data to generate a project embedding vector, retrieve candidate historical project records from a project database vector database by computing cosine similarity scores between the project embedding vector and stored project record embedding vectors, and rank the retrieved candidate historical project records by relevance score;
apply a generative neural network model to the project description data and the ranked historical project records to detect missing information fields and generate an information completeness assessment data record, and classify the project into a project complexity category based on the project embedding vector and a complexity classification model;
generate a project processing data record comprising a solution candidate sequence and an implementation procedure sequence by applying the generative neural network model to the project description data, the historical project records, and the project complexity category; and
transmit the information completeness assessment data record and the project processing data record to terminal devices via the communication interface.

2. The system according to claim 1, wherein the circuitry is configured to apply the similarity analysis to the retrieved candidate historical project records by computing feature distance metrics between the project embedding vector and each candidate record embedding vector across a plurality of similarity dimensions, generate a multi-dimensional similarity score for each candidate, and apply the generative neural network model to generate a natural language summary of the similarities and differences between the current project and each top-ranked historical project.

3. The system according to claim 1, wherein the circuitry is configured to apply the information completeness assessment model to the project description data by identifying mandatory parameter fields required for each project complexity category, comparing the received project description data against the mandatory field set, and generating the information completeness assessment data record comprising a list of missing mandatory field identifiers and clarification question text for each missing field.

4. The system according to claim 3, wherein the circuitry is configured to transmit the clarification question text to the terminal device via the communication interface, receive supplemental project description data in response, and update the project embedding vector by re-applying the natural language processing model to the updated project description data incorporating the supplemental information.

5. The system according to claim 1, wherein the circuitry is configured to apply the complexity classification model to the project embedding vector to compute a complexity score for each of a plurality of complexity dimension categories, classify the project into a standard processing category when all complexity dimension scores fall below standard threshold parameters, and classify the project into an escalation category when any complexity dimension score exceeds an escalation threshold parameter.

6. The system according to claim 5, wherein the circuitry is configured to generate an escalation routing data record for projects classified into the escalation category by applying the generative neural network model to the complexity dimension scores to identify the most relevant specialist domain identifiers, and transmit the escalation routing data record to a terminal device associated with a specialist personnel user identifier.

7. The system according to claim 1, wherein the circuitry is configured to apply a radio propagation simulation model to the facility configuration parameters and specification document data to compute signal coverage prediction data, and incorporate the signal coverage prediction data as additional context in the generative neural network model prompt for solution candidate sequence generation.

8. The system according to claim 7, wherein the circuitry is configured to apply the radio propagation simulation model to evaluate each solution candidate in the solution candidate sequence by computing a predicted coverage improvement metric, rank the solution candidates in descending order of predicted coverage improvement, and transmit the ranked solution candidates with predicted coverage improvement metrics to the terminal device.

9. The system according to claim 1, wherein the circuitry is configured to apply a specification document parsing model to structured specification document data received in the project description data by extracting technical parameter values from the specification document fields, incorporating the extracted parameter values as structured attribute features in the project embedding vector generation pipeline.

10. The system according to claim 1, wherein the circuitry is configured to update the project database vector database with new project outcome records upon project completion by generating a project outcome embedding vector from the completed project data record, indexing the project outcome embedding vector in the vector database, and storing the project outcome record with associated solution effectiveness metrics for future retrieval.

11. The system according to claim 1, wherein the circuitry is configured to apply a workflow automation model to the project processing data record by generating task assignment sequences, required document preparation sequences, and scheduling parameters derived from the implementation procedure sequence, and transmitting the workflow automation data to a task management system endpoint via the communication interface.

12. The system according to claim 1, wherein the circuitry is configured to apply a progress monitoring model to task completion status records received from the task management system endpoint via the communication interface, compute a project completion prediction score, and generate a delay risk alert when the project completion prediction score falls below a deadline risk threshold.

13. The system according to claim 1, wherein the circuitry is configured to generate a reporting data record from the project processing data record by applying the generative neural network model to produce a structured project summary comprising solution rationale, implementation schedule, and expected outcome parameters, and transmit the reporting data record to terminal devices associated with designated project stakeholder user identifiers.

14. The system according to claim 1, wherein the circuitry is configured to apply a quality verification model to the project processing data record by checking solution candidate parameters against regulatory compliance requirement records stored in the storage device, and generating a compliance assessment data record identifying any non-compliant parameters.

15. The system according to claim 1, wherein the circuitry is configured to update the generative neural network model and the complexity classification model by generating training pairs from historical project description data records and corresponding validated project outcome records, and fine-tune both models to improve classification accuracy and solution recommendation quality.

16. The system according to claim 1, wherein the circuitry is configured to apply a performance analytics model to accumulated project records and outcome data to compute process efficiency metrics, identify project types with consistently high escalation rates, and generate an improvement recommendation report for transmission to management terminal devices.

17. The system according to claim 1, wherein the project description data describes a physical environment requiring technical infrastructure modifications, the candidate historical project records comprise prior project data with solution effectiveness records, and the solution candidate sequence specifies technical configuration recommendations derived from the historical project analysis.

18. A system comprising:
circuitry configured to:
receive, via a communication interface coupled to a packet-switched network, project description data from a terminal device, apply a natural language processing model to generate a project embedding vector, and retrieve candidate historical project records by cosine similarity from a project database vector database;
apply a complexity classification model to classify the project and a generative neural network model to detect missing information fields and generate completeness assessment data;
apply a radio propagation simulation model to evaluate solution candidates and apply a generative neural network model to generate ranked solution candidate sequences; and
transmit information completeness assessments and ranked project processing data records to terminal devices.

19. The system according to claim 18, wherein the circuitry is configured to apply a workflow automation model to generate task assignment sequences for transmission to task management systems, apply a progress monitoring model to compute completion prediction scores, and apply a quality verification model to check solution parameters against regulatory compliance records.

20. A method comprising:
receiving, via a communication interface coupled to a packet-switched network, project description data from a terminal device, and storing the project description data in a storage device;
applying a natural language processing model to generate a project embedding vector, and retrieving candidate historical project records by cosine similarity from a vector database;
applying a generative neural network model to generate an information completeness assessment data record and classify the project by complexity;
generating a project processing data record comprising a solution candidate sequence and implementation procedure; and
transmitting the information completeness assessment data record and the project processing data record to terminal devices via the communication interface.
